(19) United States
(12) Patent Application Publication
(10) Pub. No.: US 2011/0317865 A1
(43) Pub. Date: Dec. 29, 2011

(54) Ergonomic System For Compact Winding And Storage Of Earphone Set/Headphones Used With Digital Media Devices

(76) Inventor: Dean Stevinson, Centennial, CO (US)

(21) Appl. No.: 13/167,662

(22) Filed: Jun. 23, 2011

Related U.S. Application Data
(60) Provisional application No. 61/357,921, filed on Jun. 23, 2010.

(51) Int. Cl. H04R 1/10

(52) U.S. Cl. 381/384

(57) ABSTRACT

A case stores an earphone set proximate to a digital media device (DMD). The case includes a top component that forms a storage compartment for storing the earphone set, and a coupling mechanism for attaching the top component to the DMD such that the storage compartment is proximate a rear side of the DMD. The earphone set may be wound onto a retaining clip that includes a first cutout sized to receive the two ear-pieces and a first pair of notches, disposed on opposite edges of the plate, about which the two wires are wound. A distance between inner segments of the notches is a function of the length of the wires such that an inline control panel and a junction splitter of the earphone set are positioned within a periphery of the retaining clip.

### RELATED APPLICATIONS

This application claims priority to U.S. patent application Ser. No. 61/357,921, titled “Protective Holder for Digital Media Device and Auxiliary Devices”, filed Jun. 23, 2010, and incorporated herein by reference.

### FIELD OF THE INVENTION

This application relates to storage for an earphone set used with a portable digital media device.

### BACKGROUND OF THE INVENTION

Hand held digital media devices (DMDs) come in many forms, such as: cellular phones, digital music players, digital video players, AM/FM radios, and so on. Most DMDs are small enough to fit in a pocket, a purse or a briefcase, and many require the user to wear an earphone set or a headset (or similar listening device) for optimal enjoyment. However, these earphone sets (or other listening devices) easily become tangled, damaged, or are lost when transported unprotected, such as when wound around a DMD or carried loose in a pocket or bag. When included, a carrying case supplied with an earphone set is typically either a bulky hard structure or a cloth bag. Bulky earphone storage cases and cloth storage bags are additional items that a user must keep track of Although cloth bags are not bulky, they do nothing to neatly store and organize the earphone set. As a result, earphone sets/headsets are usually stored separate from the DMD and are thus easily lost, or are wrapped around the DMD and exposed to damage, and further inhibit use of the DMD.

### SUMMARY

In one embodiment, a retaining clip securely captures and stores an earphone set. The earphone set comprising two ear-pieces, a length of cable divided into two wires at a junction splitter. Each of the wires couples to a different one of the earpieces and one of the wires has an inline control panel coupled thereto. An undivided end of the cable couples to a jack plug. The retaining clip includes a plate shaped and sized to securely capture the earphone set. The plate includes a first cutout sized to receive the two ear-pieces and a first pair of notches, disposed on opposite edges of the plate, about which the two wires are wound. The distance between inner segments of the notches is a function of the length of the wires such that the inline control panel and the junction splitter are positioned within a periphery of the retaining clip when the two wires are completely wound around the plate in a winding path between the notches. The jack plug is retained within the periphery by the wires and the cable when the wires and the cable are wound around the plate.

In another embodiment, a case stores an earphone set proximate to a digital media device (DMD). The case includes a top component that forms a storage compartment for storing the earphone set, and a coupling mechanism for attaching the top component to the DMD such that the storage compartment is proximate a rear side of the DMD.

In another embodiment, a case stores an earphone set proximate to a digital media device (DMD). The case includes a protective DMD case that couples with the DMD, a storage compartment formed from stretchable material with an opening for accessing the storage compartment, and a retention clip for holding the earphone set in the storage compartment. The storage compartment is coupled to the protective DMD case, and the stretchable pocket conforms to a contour of the retention clip and the earphone set held thereby. The retention clip is removable from the storage compartment through the opening.

In another embodiment, a retractable earphone storage case stores an earphone set proximate to a digital media device (DMD). The case includes a DMD protective case, a storage compartment with at least one opening positioned on a rear of the DMD protective case, and a retractable mechanism positioned within the storage compartment for storing the earphone set such that the earphone set may be withdrawn from the case.

### BRIEF DESCRIPTION OF THE FIGURES

FIG. 1 shows first exemplary prior art earphone set with ear-bud style earpieces.

FIG. 2 shows second exemplary prior art earphone set with in-ear style earpieces.

FIG. 3 shows the earphone set of FIG. 2 with a prior art lapel clip.

FIG. 4 shows fourth exemplary prior art earphone set with in-ear style earpieces, a combined remote control and microphone and junction splitter, and a lapel clip.

FIG. 5A shows one exemplary earphone retaining clip with winding notches and an earpiece alignment notch, in an embodiment.

FIGS. 5B, 5C, and 5D are various views of the retaining clip of FIG. 5A retaining the earphone set of FIG. 2.

FIGS. 6A, 6B and 6C are various views of one exemplary earphone retaining clip with winding notches, two earpiece retaining cutouts, and a jack plug retaining cutout, in an embodiment.

FIGS. 6D, 6E, and 6F are various views of the retaining clip of FIGS. 6A, 6B and 6C retaining the earphone set of FIG. 1.

FIG. 7A shows one exemplary earphone retaining clip with two earpiece retaining cutouts, winding notches with two different distances and an earpiece alignment notch, in an embodiment.

FIGS. 7B, 7C, 7D, 7E, 7F, 7G, and 7H are various views showing the retaining clip of FIG. 7A retaining the ear-bud style earphone set of FIG. 1.

FIGS. 8A and 8B are different views of one exemplary earphone retaining clip with an earpiece retaining cutout, winding notches, and a jack plug retaining cutout, in an embodiment.

FIG. 8C shows the earphone retaining clip of FIGS. 8A and 8B retaining the earphone set of FIG. 1.

FIGS. 9A and 9B are views of one exemplary earphone retaining clip with two earpiece retaining cutouts, and winding notches, in an embodiment.

FIG. 9C shows the earphone retaining clip of FIGS. 9A and 9B retaining the earphone set of FIG. 1.

FIGS. 10A, 10B, and 10C are various views showing one exemplary earphone retaining clip that is shaped and sized for storing in-ear style earphone set, in an embodiment.

FIGS. 10D and 10E show the earphone retaining clip of FIGS. 10A, 10B and 10C, retaining the earphone set of FIG. 2.

FIG. 11A shows one exemplary in-ear style earphone retaining clip that provides additional protection of the earphone set, in an embodiment.

FIGS. 11B-H illustrate exemplary winding of the earphone set of FIG. 4 onto the earphone retaining clip of FIG. 11A.

FIGS. 12A-G are various views of one exemplary retaining and protective clip for retaining in-ear style earphone set, in an embodiment.

FIGS. 12H-L show exemplary winding of the earphone set of FIG. 3 on the clip of FIGS. 12A-G.

FIGS. 13A-D show an exemplary earphone storage device using the clip of FIGS. 12A-L integrated with a stretchable pouch, in an embodiment.

FIGS. 14A-C show an exemplary carrying case for storing an earphone set wound onto the retaining clip of FIGS. 8A and 8B, in an embodiment.

FIGS. 14D-F show use of the carrying case of FIGS. 14A-C for storing the earphone set of FIG. 1 wrapped onto the earphone retaining clip of FIGS. 8A-C, in an embodiment.

FIG. 15 shows one exemplary storage case, similar to the carrying case of FIGS. 14A-F, that attaches to a digital media device (DMD) for storing an earphone set (or other items) together with the DMD, in an embodiment.

FIG. 16 shows one exemplary storage case attached to a DMD by a hook and loop method for storing an earphone set and a retaining clip such as the clip of FIGS. 6A-C, together with the DMD, in an embodiment.

FIGS. 17A-D are various views of one exemplary system for attaching the storage case of FIG. 15 or FIG. 16 to a DMD, in an embodiment.

FIGS. 18A-D are various views showing one exemplary hard shell carrying case formed as an earphone storage case and DMD protection case that couple together, in an embodiment.

FIGS. 19A-D show one exemplary hard shell carrying case that is similar to the earphone storage case of FIGS. 18A-D but formed with a flat slot across the finger grips to accommodate a hand strap used with DMD, in an embodiment.

FIGS. 20A-B are perspective views showing one exemplary earphone storage and DMD protection case with a slide coupling between a storage compartment and a protective DMD case, in an embodiment.

FIG. 20C shows one exemplary hard shell earphone storage and DMD protection case with a slide coupling between a storage compartment and a protective DMD case, in an embodiment.

FIGS. 21A-C and 21D are end and bottom views, respectively, showing one exemplary hard shell earphone storage and DMD protection case with a slide coupling between a storage compartment and a protective DMD case, in an embodiment.

FIGS. 22A-C are various views of one exemplary hard shell earphone storage and DMD protection case with a slide coupling between a storage compartment and a protective DMD case, in an embodiment.

FIGS. 23A-C are various views of one exemplary zippered storage case for protecting a DMD and storing accessories, in an embodiment.

FIGS. 24A and 24B are perspective views of one exemplary combined earphone storage and DMD protection case coupled with a bottom surface of a DMD, in an embodiment.

FIGS. 25A-D are perspective views of one exemplary earphone retaining clip for use with a stretchable cover integrated with a DMD protective case, in an embodiment.

FIGS. 26A-I and 26J are side views and a perspective view, respectively, of one exemplary split storage and protective case 2600 that protects a DMD and provides storage for an earphone set, in an embodiment.

FIGS. 27A-E illustrate one exemplary sprung storage and protective case for a DMD, in an embodiment.

FIGS. 28A-E are various views of one exemplary integrated hard storage and protective case, in an embodiment.

FIGS. 29A-C are various views of one exemplary shaped earphone retaining clip for retaining an in-ear style earphone set using reduced height, in an embodiment.

FIGS. 29D-F show exemplary winding of the earphone set of FIG. 2 onto the earphone retaining clip of FIGS. 29A-C.

FIGS. 30A-F show a retractable earphone set in one exemplary storage case that attaches to a protective case of a DMD, in an embodiment.

FIGS. 31A and 31B are side views of one exemplary storage case for storing a Bluetooth earpiece with a DMD, in an embodiment.

FIG. 31C shows a foam former of the storage case of FIGS. 31A and 31B.

FIGS. 32A and 32B show one exemplary storage case configured to replace a battery compartment cover for a DMD, in an embodiment.

FIG. 33 is a top view of one exemplary earphone set storage clip formed with a base portion that is substantially flat with a raised former that has recesses sized and shaped to receive earpieces of an earphone set, in an embodiment.

FIG. 34 is a top view of one exemplary earphone set storage clip formed with a base portion that is substantially flat, narrow, and has a raised former with recesses sized and shaped to receive earpieces of an earphone set, in an embodiment.

### DETAILED DESCRIPTION

The present disclosure may be understood by reference to the following detailed description considered in conjunction with the drawings. Note that, for purposes of illustrative clarity, certain elements in the drawings are not drawn to scale. Reference numbers for items that appear multiple times may be omitted for clarity. Where possible, the same reference numbers are used throughout the drawings and the following description to refer to the same or similar parts.

In the following embodiments, reference is made to a digital media device (DMD) that may be selected from the group including an iPod, an iPhone, an iPad, an iTouch, a notebook computer, a laptop computer, a personal DVD player, an MP3 player, a cell phone, a hand-held recording device and a personal digital assistant (PDA).

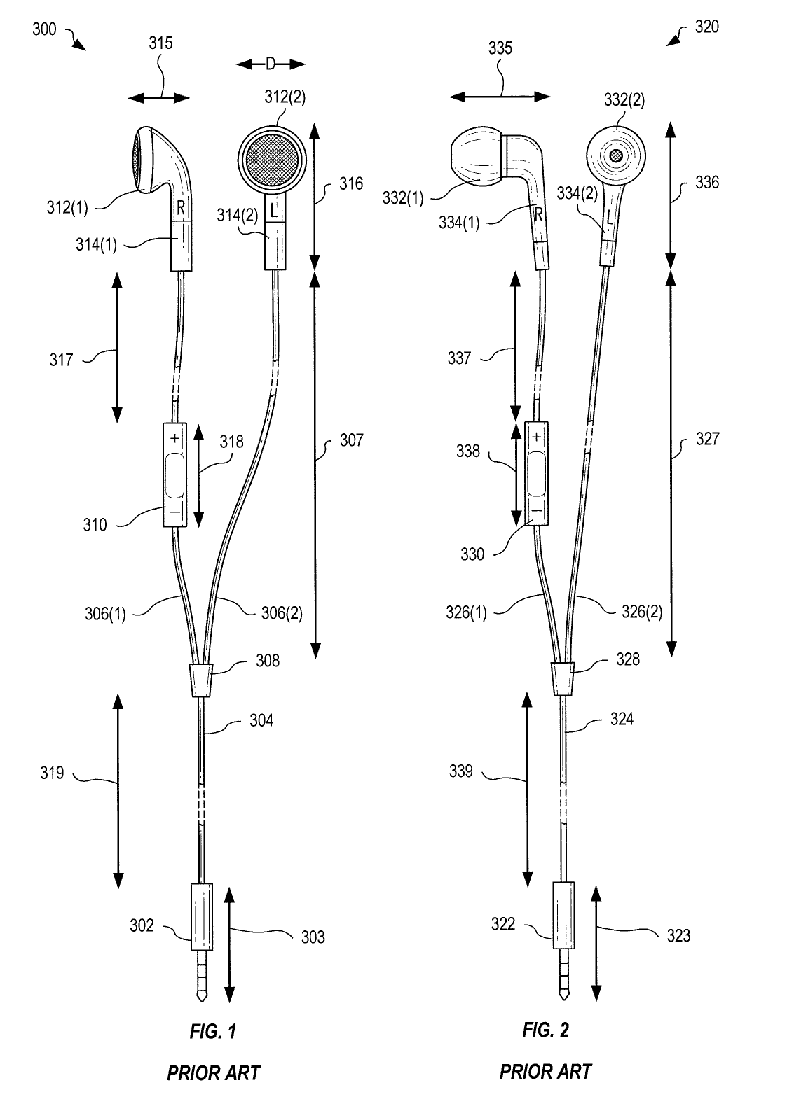

FIGS. 1 through 4 show exemplary earphone sets and their characteristics. These earphone sets are used to illustrate use of retaining clips and storages cases in certain embodiments described herein. Although a particular earphone may be used to describe a certain feature, features of other earphone sets may also apply. That is, within the described embodiments, earphone sets may be interchangeable without departing from the scope hereof.

FIG. 1 shows a first exemplary prior art earphone set 300 with a jack plug 302 coupled with a cable 304 that splits into wires 306(1) and 306(2) at a junction splitter 308, a remote control and microphone 310 positioned inline with wire 306(1), and two ear-bud style earpieces 312(1) and 312(2), each having a stem 314(1) and 314(2) that couples to wires 306(1) and 306(2), respectively. Earpieces 312 have a diameter D that allows their use within a human ear. Earpieces 312 have a depth 315 and a length 316. Remote control and microphone 310 has a length 318 and is positioned a distance 317 from stem 314(1) along wire 306(1), which has an overall length 307. Cable 304 has a length 319 from junction splitter 308 to jack plug 302, which has a length 303. Jack plug 302, junction splitter 308, remote control and microphone 310, and earpieces 312 are substantially rigid. Earphone set 300 may represent prior art ear-bud style earphone sets sold by Apple™, for example.

FIG. 2 shows second exemplary prior art earphone set 320 of an in-ear style that include a jack plug 322 coupled with a cable 324 that splits into wires 326(1) and 326(2) at a junction splitter 328, a remote control and microphone 330 positioned inline with wire 326(1), and two in-ear style earpieces 332(1) and 332(2), each having a stem 334(1) and 334(2) that couples to wires 326(1) and 326(2), respectively. Dimension of earphone set 320 may be similar to those of earphone set 300, except that depth 335 may be larger than depth 315 due to the in-ear styling. Earpieces 332 have a depth 335 and a length 336. Remote control and microphone 330 has a length 338 and is positioned a distance 337 from stem 334(1) along wire 326(1), which has an overall length 327. Cable 324 has a length 339 from junction splitter 328 to jack plug 322, which has a length 323. Jack plug 322, junction splitter 328, remote control and microphone 330, and earpieces 332 are substantially rigid. Earphone set 320 may represent in-ear style prior art earphone devices sold by Apple™, for example.

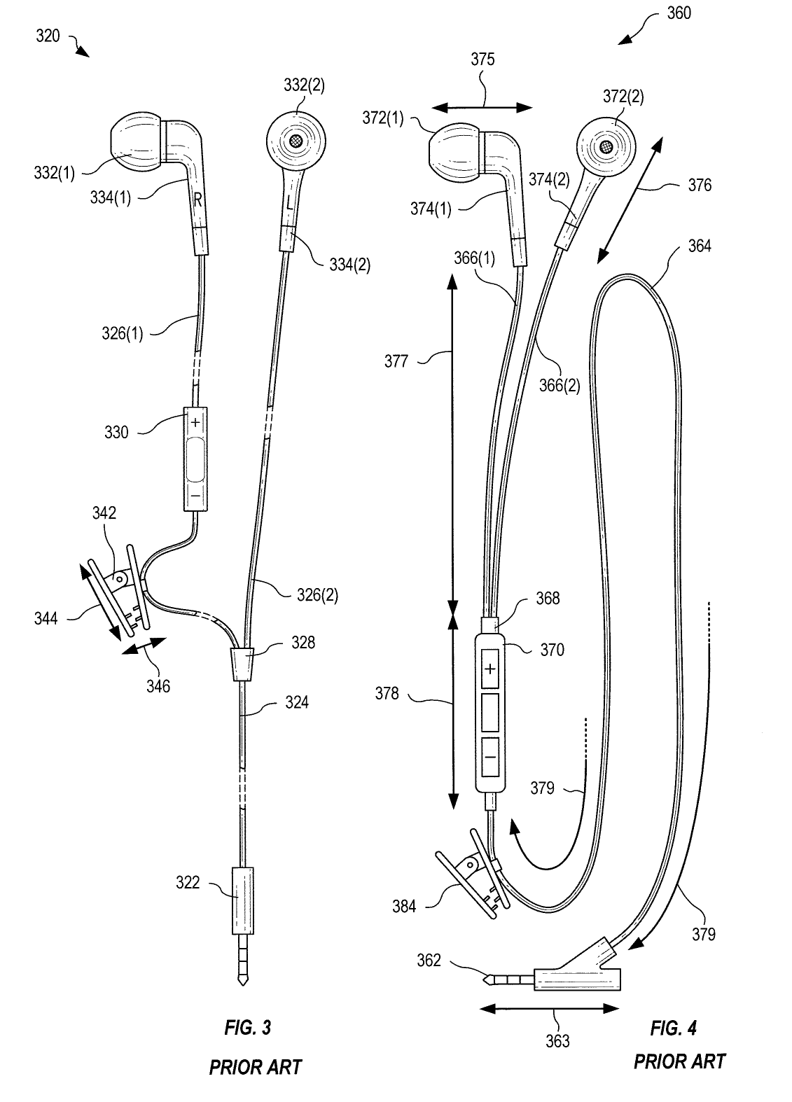

FIG. 3 shows earphone set 320 of FIG. 2 with an additional prior art lapel clip 342 positioned on wire 306(1) below remote control and microphone 330. Lapel clip 342 forms another rigid structure of earphone set 320 with a width 346 and length 344.

FIG. 4 shows fourth exemplary earphone set 360 with a jack plug 362 coupled with a cable 364 that splits into wires 366(1) and 366(2) at a junction splitter 368 that is combined with a remote control and microphone 370 positioned inline with cable 364, a lapel clip 384 and two in-ear style earpieces 372(1) and 372(2), each having a stem 374(1) and 374(2) that couples to wires 366(1) and 366(2), respectively. Earpieces 372 have a depth 375 and a length 376. Remote control and microphone 370 has a length 378. Wires 366 each have a length 377. Cable 364 has a length 379 from remote control and microphone 370 to jack plug 362, which has a length 363. Jack plug 362, junction splitter 368, remote control and microphone 370, and earpieces 372 are substantially rigid. Earphone set 360 may represent prior art in-ear style earphone devices sold by V-Moda™, for example.

It should be noted that size and position of rigid components vary for earphone sets from different manufacturers, and for different models from the same manufacturer. Safe storage of earphone sets 300, 320, and 360 thus requires either a dedicated retaining clip or a versatile clip that allows positioning of rigid components for optimal compactness, or for optimal fit to an ergonomically styled case, as described in detail below.

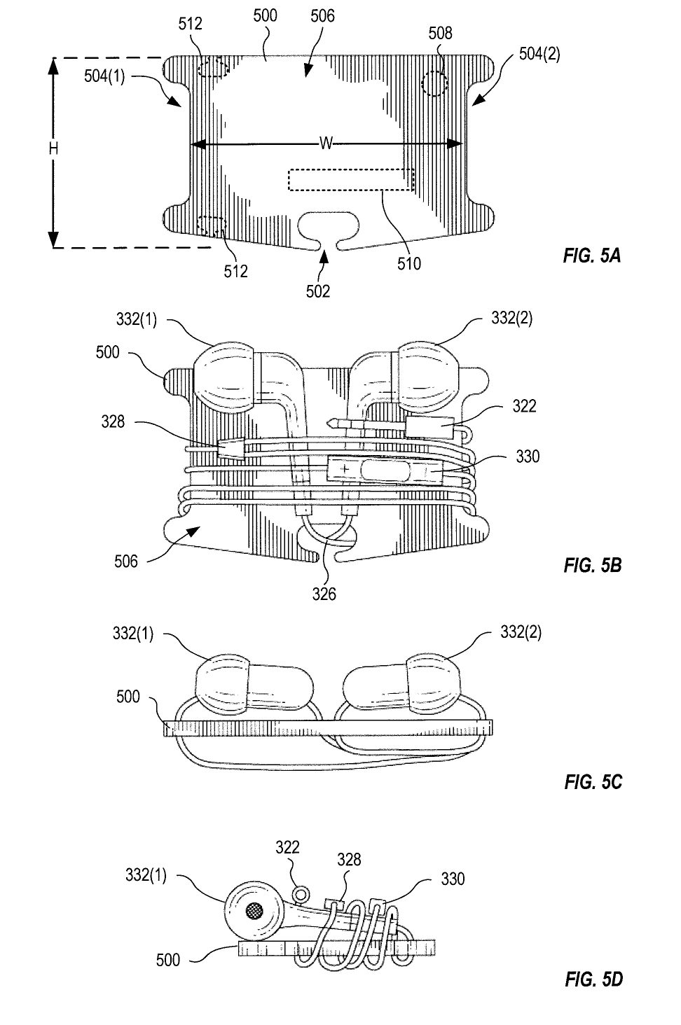

FIG. 5A shows one exemplary earphone retaining clip 500 with winding notches 504(1) and 504(2) and an alignment notch 502. Clip 500 is formed from a substantially flat material, such as plastic and/or metal, or any other easily fabricated material. FIGS. 5B, 5C, and 5D show alternate views of retaining clip 500 of FIG. 5A retaining earphone set 320 of FIG. 2. FIGS. 5A-D are best viewed together with the following description.

Notch 502 receives wires 326 with earpieces 332 positioned against a front surface 506 of retaining clip 500, as shown in FIG. 5B. Winding notches 504 have a distance W between inner segments thereof Distance W is selected, based upon earphone set 320, such that as wires 326 and cable 324 are wound around winding notches 504, earpieces 332 are retained in position and junction splitter 328, remote control and microphone 330, and jack plug 322 lay adjacent to front surface 506 without any substantial slack in cable 324 and wires 326. Retaining clip 500 neatly retains earphone set 320. Height H and distance W of clip 500 are selected based, at least in part, upon measurements 334-341 of earphone set 320. In particular, height H and distance W of clip 500 may be selected based upon size of rigid components 312, 310, 308, and 302, and lengths 307, 317, and 319 of earphone set 300, such that earphone set, when wrapped on clip 500, are tidy and take up as small a space as possible. Distance W is equal or greater than a maximum of length 303 and length 318, for example, such that jack plug 302 and inline control panel 310 may be positioned between edges of notches 505. Optionally, clip 500 may include one or more securing holes 508, through which jack plug 322 may be passed to prevent cable 304 (and wires 306) from unwinding, and/or a jack plug retaining slot 510 for receiving jack plug 322 such that jack plug 322 may be tucked under, and retained by, windings of cable 304 and/or wires 306. Clip 500 may also optionally include one or more additional notches 512 that allow the length of one or more windings to be varied when clip 500 is used for retaining earphone sets of different lengths. Thus, earphone retaining clip 500 may be manufactured to retain in-ear style headphones, such as sold by Apple™ and V-Moda™, among others.

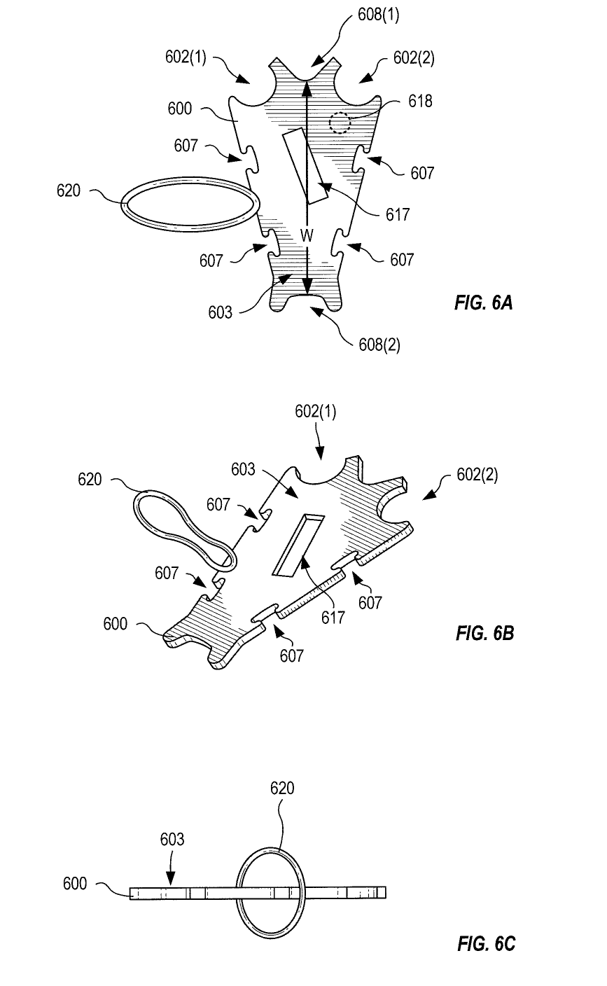

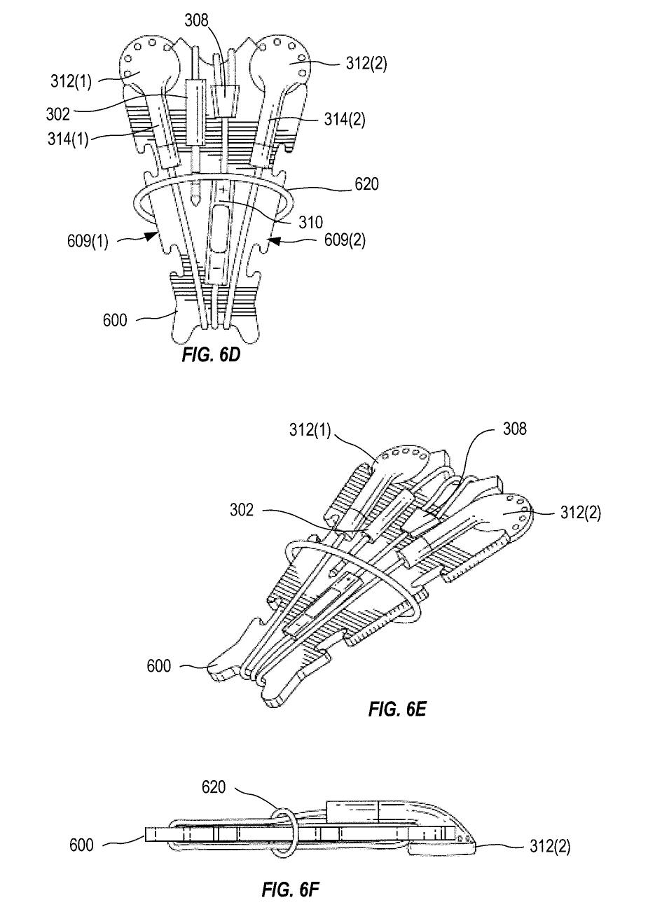

FIGS. 6A, 6B and 6C show views of one exemplary earphone retaining clip 600 with winding notches 608(1) and 608(2), two earpiece retaining cutouts 602(1) and 602(2), a jack plug retaining cutout 617, and a plurality of notches 607. Clip 600 is formed from a substantially flat material, such as plastic or other easily fabricated material. Optionally, clip 600 includes a retaining band 620 made out of elastic material that may be used to further secure the earphone set wound onto clip 600. Earphone retaining clip 600 is ideally suited for retaining earphone sets with ear-bud style earpieces such as earphone set 300 of FIG. 1.

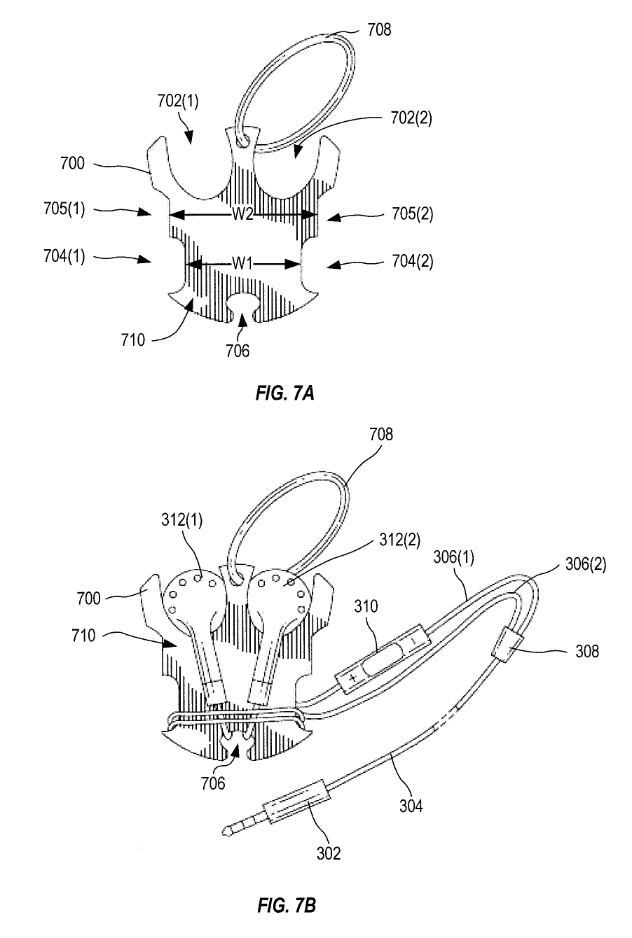

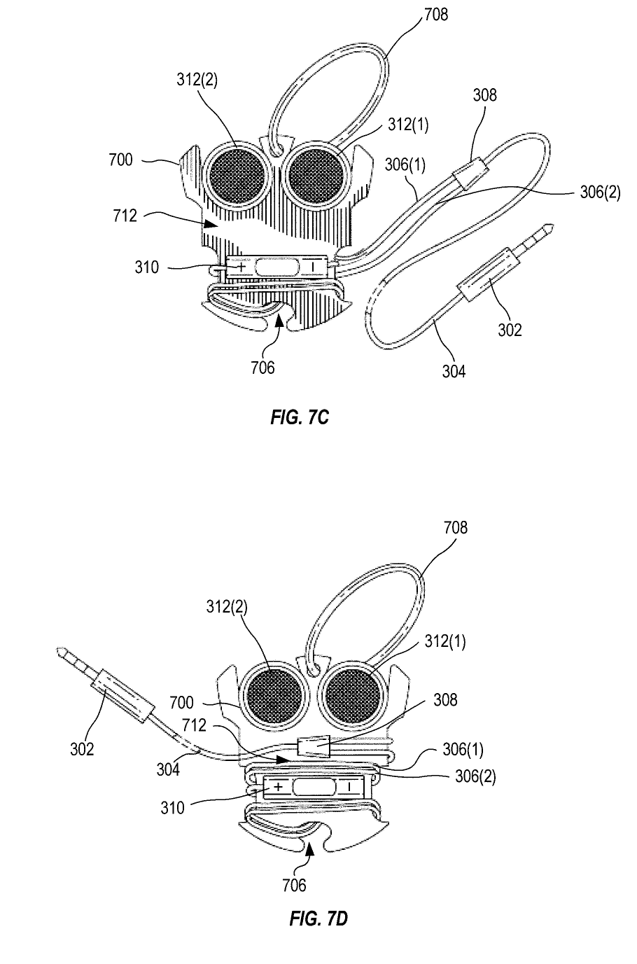

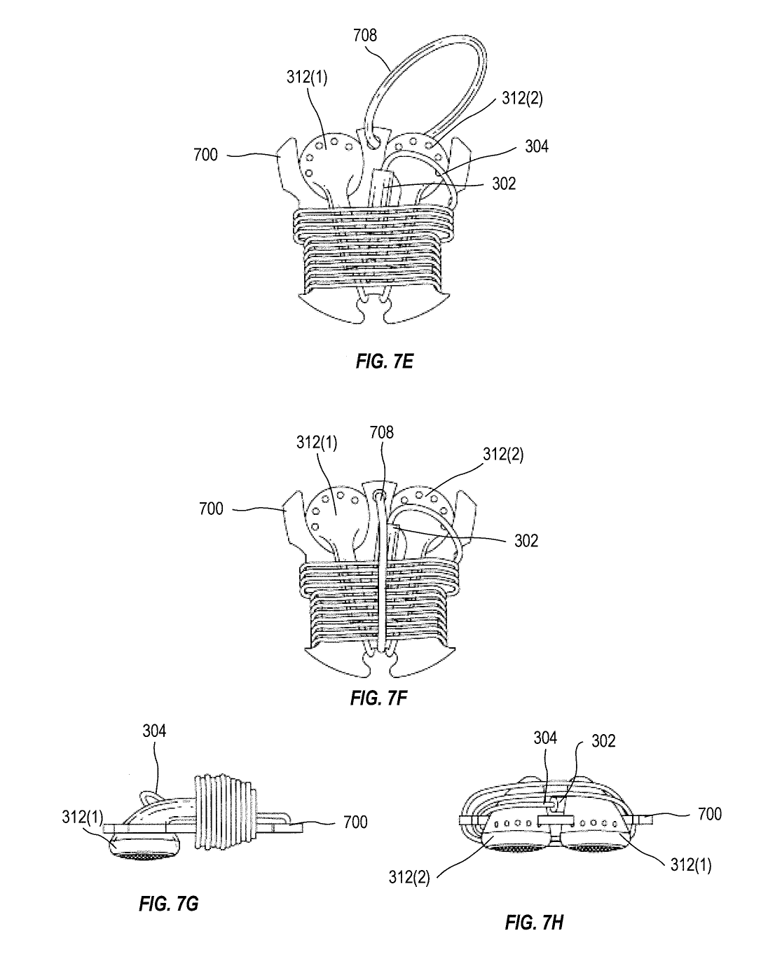

Winding notches 608 are formed with a distance W between inner segments thereof. Clip 600 allows an earphone set to be wound around winding notches 608 resulting in a winding with fewer turns and with a thinner profile, as compared to winding on clips 700, 800, and 900 of FIGS. 7, 8 and 9, described below. Clip 600 is particularly suited for use where larger areas (e.g., when associated with larger digital media devices) are available for storage of the earphone set. Optionally, clip 600 may include one or more holes 618, through which jack plug 302 may be passed to help secure the earphone set onto clip 600.

Earphone sets of various dimensions may be wound neatly onto earphone retaining clip 600 by passing cable 304 and/or wires 306, for one or more turns, through one or more notches 607 rather than around winding notches 608, as needed to adjust the position of the rigid components (e.g., remote control and microphone 310, junction splitter 308, and jack plug 302) of the earphone set. Specifically, by winding cable 304 and/or wires 306 through one or more notches 607 instead of around winding notches 608, junction splitter 308 and remote control and microphone 310 may be positioned adjacent a front surface 603 of clip 600 and jack plug 302 may be positioned within jack plug retaining cutout 617 without leaving slack in cable 304 and wires 306. In particular, rigid components of earphone set 300 may be positioned within a periphery of clip 600.

FIGS. 6D, 6E, and 6F show front, perspective and side views of retaining clip 600 of FIGS. 6A, 6B and 6C retaining earphone set 300 of FIG. 1. Rigid components 302, 308, and 310 of earphone set 300 are positioned within a periphery (that is, inside the boundaries) of retaining clip 600 and earphone set 300 are neatly organized on clip 600 for easy storage. Earpiece retaining cutouts 602 are located at one end of clip 600.

Earpieces 312 are positioned within cutouts 602 and wrapping of wires 306 and cable 304 proceeds around winding notches 608 (see, e.g., FIG. 6A). If rigid components 308 and 310 are not positioned as desired with front surface 603 (e.g., relatively flush with front surface 603) component 310, wires 306 may be passed through one or more of notches 607 to adjust a winding length of one or more turns until rigid components 308, 310 are positioned within the periphery of front surface 603. In one example of winding, wires 306 and/or cable 304 passes through one notch 607 and then wraps around secondary winding edges 609(1) and 609(2) (i.e., substantially perpendicular to winding notches 608). Secondary winding edges 609 are not parallel. Jack plug 302 is positioned within (i.e., tucked into) jack plug cutout 617 beneath wound wires 306 and cable 304.

By including notches 607, a winding length of each turn of wires and cables onto clip 600 may be adjusted to match most earphone configurations, such that long axes of the rigid components are positioned substantially parallel to front surface 603 of clip 600.

FIG. 7A shows one exemplary earphone retaining clip 700 with two earpiece retaining cutouts 702(1) and 702(2), two first winding notches 704(1) and 704(2) and two second winding notches 705(1) and 705(2) that have different winding widths W1 and W2, respectively, and an earpiece alignment notch 706 for compact storage of an earphone set (e.g., earphone set 300 of FIG. 1). Clip 700 may optionally include an elastic band 708 for use in securing wrapped the earphone set to clip 700. Cutouts 702(1) and 702(2) are partially open to allow easy insertion of earpieces 312(1) and 312(2), respectively. Cutouts 702(1) and 702(2) are also shaped (e.g., rounded) based upon the shape of earpieces 312 and are sized slightly smaller than the largest diameter D of earpieces 312. A distance W1 between inner segments of winding notches 704(1) and 704(2) and a distance W2 between inner segments of winding notches 705(1) and 705(2) are determined based upon dimensions of earphone set 300, such that as wires 306 and cable 304 are wound around winding notches 704 and 705, earpieces 312 are retained in position in cutouts 702, and junction splitter 308, remote control and microphone 310 and jack plug 302 lay adjacent to front surface 710 without any substantial slack in cable 304 and wires 306.

FIGS. 7B, 7C, 7D, 7E, 7F, 7G, and 7H show views of exemplary wrapping of ear-bud style earphone set 300 of FIG. 1 around retaining clip 700 of FIG. 7A. Precise dimensioning of clip 700 allows earphone set 300 to be wrapped and stored very compactly, thereby allowing easy storage of earphone set 300.

Earpieces 312(1) and 213(2) are positioned in cutouts 702(1) and 702(2) such that stems 314 lay on a front surface 710 of clip 700 and wires 306 pass through alignment notch 706 from front to back, as shown in FIG. 7B. Wires 306 are then wrapped around winding notches 704 such that remote control and microphone 310 (a rigid structure) is aligned substantially parallel to a reverse surface 712 (opposite front surface 710) without extending beyond the periphery of clip 700, as shown in FIG. 7C. Winding of wire 306 continues around winding notches 704 and onto winding notches 705 such that junction splitter 308 (another rigid part) is also positioned parallel to surface 712 and within a periphery of clip 700, as shown in FIG. 7D. Winding of cable 304 continues around winding notches 705 until jack plug 302 may be inserted in a space between stems 314 and beneath cable 304, as shown in FIG. 7E. Jack plug 302 is thereby positioned substantially flat against front surface 710 and without unnecessary slack in wires 306 and cable 304. If included, optional elastic band 708 may be positioned around earphone set 300 retained by clip 700, as shown in FIG. 7F. Since distance W2 is greater than distance W1, fewer turns are required to store cable 304.

In one embodiment, the overall dimensions of wrapped earphone set 300 onto retaining clip 700 are approximately 1½ inches, by 1½ inches, by ⅝ of an inch, which makes it small enough to be stored compactly against the back of a digital music device while allowing the user full function of all DMD features, such as using handheld cell phone features. See for example, FIGS. 7F, 7G, and 7H. Earphone set 300 is easily removed from clip 700 without damage or tangling. Further, the compact nature of earphone set 300 wrapped on clip 700 allows easy storage, as described below.

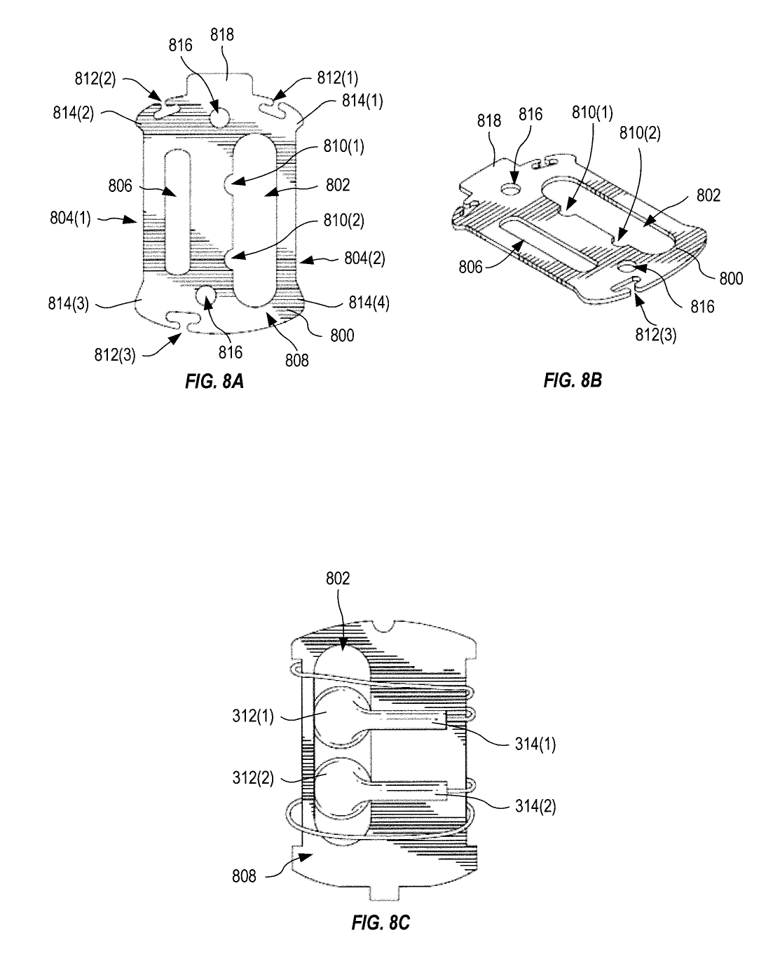

FIGS. 8A and 8B show two views of one exemplary earphone retaining clip 800 with an earpiece retaining cutout 802, winding notches 804, and a jack plug retaining cutout 806, in an embodiment. FIG. 8C shows the earphone retaining clip of FIGS. 8A and 8B retaining earphone set 300 of FIG. 1. FIGS. 8A, 8B and 8C are best viewed together with the following description.

Earpiece retaining cutout 802 is shaped and sized to capture earpieces, such as earpieces 312, 332, and 372, of FIGS. 1, 2 and 4, respectively. As shown in FIG. 8C, earpieces 312 may be inserted through cutout 802 such that stems 314 lie flat on a front surface 808 of clip 800. Cutout 802 may include notches 810(1) and 810(2) for aligning stems 314(1) and 314(2), respectively. When used for in-ear earpieces 332, 372, each earpiece is laid flat along cutout 802, rather than though it, in a similar positions to earpieces 332 of FIG. 5B. Clip 800 may include a connector 818 for coupling with a storage case, described in further detail below.

To wind earphone set 300 onto clip 800, first earpieces 312 are positioned within cutout 802, wires 306 and cable 304 are then wound around winding notches 804(1) and 804(2) such that rigid portions (e.g., remote control and microphone 310) of earphone set 300 are positioned within the periphery of clip 800. Clip 800 includes additional notches 812 that may be used to alter winding of wires 306 and/or cable 304 of earphone 300 such that the rigid portions are positioned within the periphery of clip 800. Once cable 304 is wrapped around winding notches 804, jack plug 302 is then tucked into jack plug retaining cutout 806 behind cable 304 and wires 306. Wrapping is maintained to a specified width through the use of side rails 814 that extend a desired distance from upper and lower “corners” of clip 800 to define a winding path between winding notches 804. Edges or other portions of clip 800 that are not used to accumulate winding of cable 304 and wires 306 may be used to hold clip 800 (e.g., between the fingers of one hand of the user) while wrapping the earphone set around clip 800 with the other hand. Additional notches 812 are provided to assist the user in completing the wrap of earphone set 300 successfully. For example, in the event rigid components 302, 308, and 310 do not lay parallel to surfaces 808, or protrude outside the periphery of clip 800, notches 812 may be used to shorten the length of one or more winding turns to reposition one or more rigid components of earphone 300. One or more cord capture holes 816 allows jack plug 302 pass through and then be stored within jack plug capture cutout 806.

In one embodiment, clip 800 has a thickness of approximately ⅛ inch. Cutouts 802 and 806 are positioned within the periphery of clip 800 such that earpieces 312 and jack plug 302 are stored with minimal increase in overall thickness of clip 800 when wound with earphone set 300, as compared to positioning of earpieces 312 and jack plug 302 on surface 808.

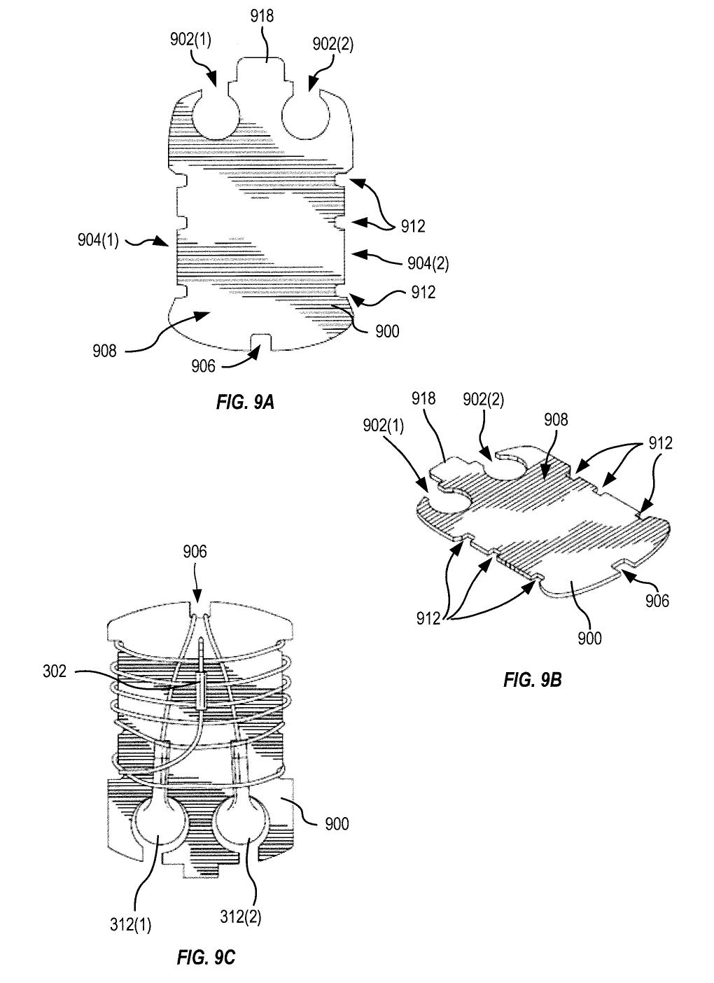

FIGS. 9A and 9B show two views of one exemplary earphone retaining clip 900 with two earpiece retaining cutouts 902(1) and 902(2), an alignment notch 906, and winding notches 904. FIG. 9C shows earphone retaining clip 900 of FIGS. 9A and 9B retaining earphone set 300 of FIG. 1. FIGS. 9A, 9B and 9C are best viewed together with the following description.

Earpiece retaining cutouts 902 are shaped and sized to capture ear-bud style earpieces, such as earpieces 312 of FIG. 1. As shown in FIG. 9C, earpieces 312 are inserted within cutouts 902 such that stems 314 lie flat on a front surface 908 of clip 900. Clip 900 may include a connector 918 for coupling with a storage case, described in further detail below.

To wind earphone set 300 onto clip 900, first earpieces 312 are positioned within cutouts 902, wires 306 are passed through alignment notch 906, and wires 306 and cable 304 are then wound around winding notches 904(1) and 904(2) such that rigid portions (e.g., junction splitter 308 and remote control and microphone 310) of earphone set 300 are positioned within the periphery of clip 900. Clip 900 includes additional notches 912 that may be used to alter a winding length of one or more turn of wires 306 and/or cable 304 of earphone 300 such that the rigid portions are positioned within the periphery of clip 900. Once cable 304 is wrapped around winding notches 904, jack plug 302 is then tucked behind cable 304 and wires 306. In one embodiment, clip 900 has a thickness of approximately ⅛ inch and is contoured to minimize thickness and provide better fit to components.

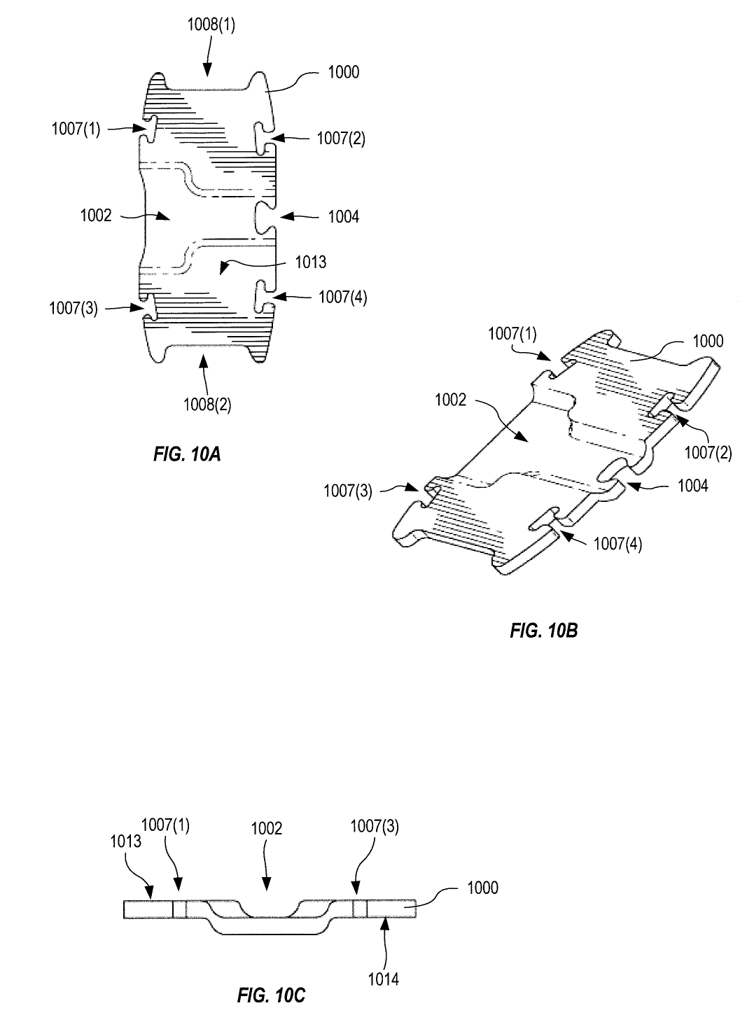

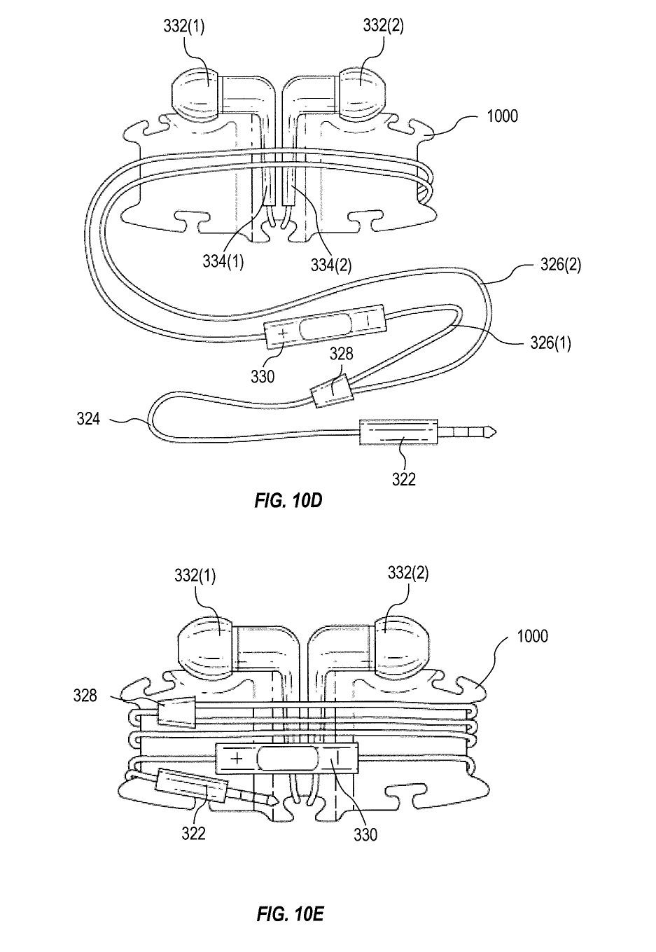

FIGS. 10A, 10B, and 10C show one exemplary earphone retaining clip 1000 that is shaped and sized for storing in-ear style earphone sets, such as earphone sets 320 and 360 of FIGS. 2 and 4. FIGS. 10D and 10E show earphone retaining clip 1000 of FIGS. 10A, 10B and 10C, retaining earphone set 320 of FIG. 2. FIGS. 10A, 10B, 10C, 10D, and 10E are best viewed together with the following description.

Earphone retaining clip 1000 includes a shaped area 1002 for receiving in-ear style earpieces (e.g., earpieces 332 of earphone set 320), an earpiece alignment notch 1004 for receiving wires 326, winding notches 1008(1) and 1008(2) for winding wires 326 and cable 324, and a plurality of additional notches 1007 that may be used for positioning rigid components 328 and 330 within a periphery of clip 1000.

To wrap earphone set 320 on earphone retaining clip 1000, earpieces 332 are positioned within shaped area 1002 and wires 326 are passed through alignment notch 1004, and then wound around winding notches 1008. Where clip 1000 is correctly dimensioned for earphone set 320, rigid components 322, 328 and 330 of earphone set 320 are positioned within a periphery of clip 1000 and substantially parallel to a top surface 1013 or a bottom surface 1014 of clip 1000. Where one or more rigid components 322, 328 and 330 are not positioned within a periphery of clip 1000, wires 326 and/or cable 324 may be passed through one (or more) of the additional notches 1007 for one or more turns such that the components are positioned within the periphery. That is, additional notches 1007 may be used to adjust the amount of wires and/or cable taken up by one or more turns. Clip 1000 may optionally include an elastic band (not shown) for retaining the earphone set wound onto clip 1000.

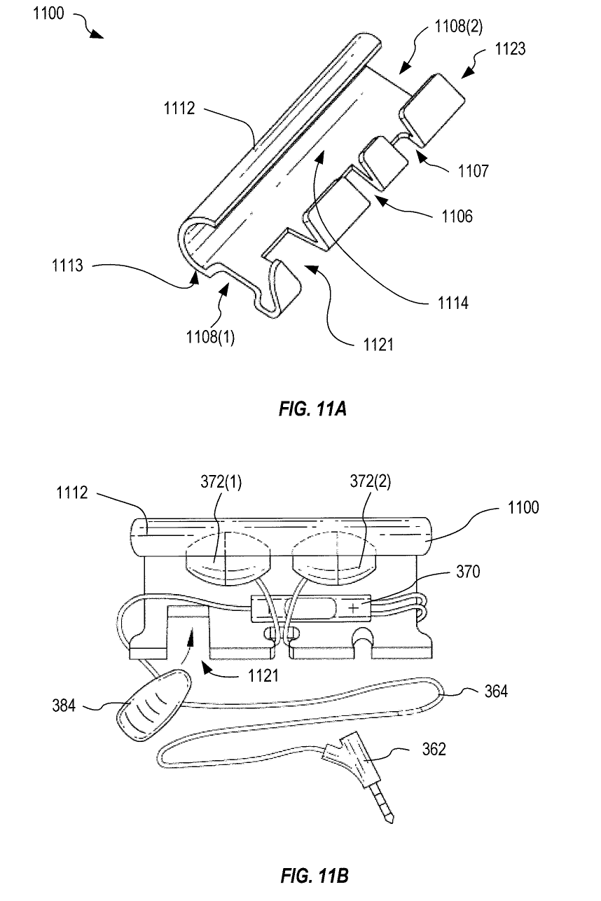

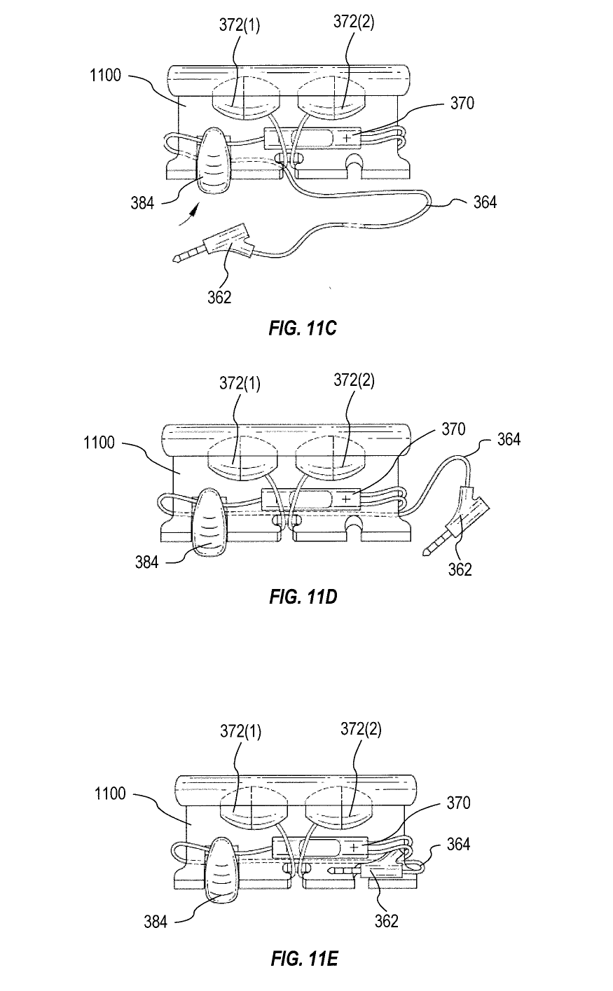

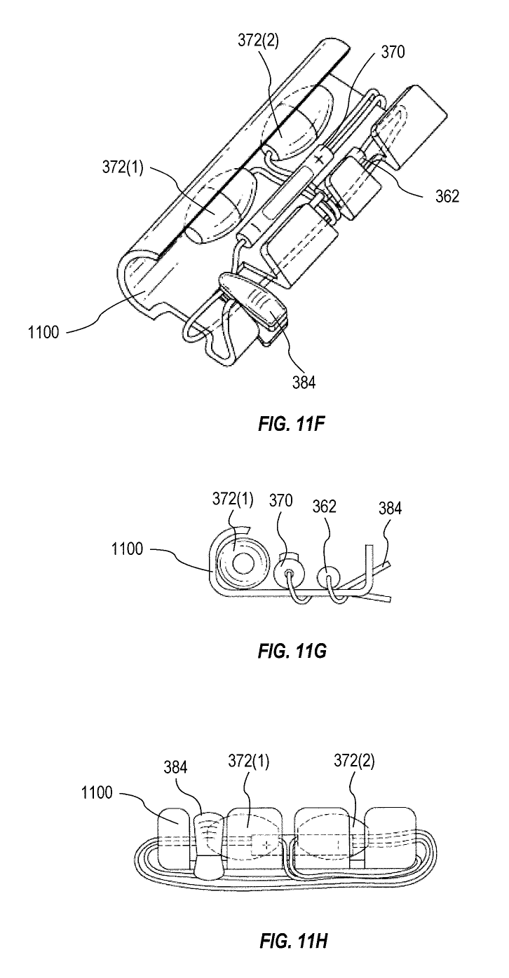

FIG. 11A shows one exemplary in-ear style earphone retaining clip 1100 that provides additional protection of the earphone set. FIGS. 11B-H illustrate exemplary winding of earphone set 360 of FIG. 4 onto earphone retaining clip 1100 of FIG. 11A. FIGS. 11A-H are best viewed together with the following description.

Clip 1100 has a substantially flat base 1114 that is approximately rectangular. A curved (substantially “C” shaped) edge 1112 is formed along a first long edge of base 1114 and is sized and shaped to receive in-ear earpieces, such as earpieces 372. Edge 1112 provides additional protection for stored earpieces 372, which may be sensitive and expensive components, as compared to clips 500, 600, 700, 800, 900, and 1000 of FIGS. 5, 6, 7, 8, 9, and 10, respectively. Winding notches 1108(1) and 1108(2) are formed in short edges of base 1114, and opposite to curved edge 1112 is a folded edge 1123 that is substantially at a right-angle to base 1114 and folded in an opposite direction as edge 1112 (for example, folded towards edge 1112). Folded edge 1123 includes an alignment notch 1106 that is substantially central in edge 1123 and a lapel clip notch 1121 that extends into base 1114 for receiving lapel clip 384. Folded edge 1123 also includes an additional notch 1107 that may be used to adjust the length of one or more turns to position rigid components 362, 368, and 370 of earphone 360 within a periphery of clip 1100.

To wind earphone set 360 onto clip 1100, earpieces 372 are positioned within curved edge 1112 and wires 366 are passed through alignment notch 1106. Wires 366 and cable 364 are then wrapped around winding notches 1108(1) and 1108(2) such that rigid components 368 and 370 are positioned substantially parallel to an outside surface 1113 of base 1114 and within the periphery of clip 1100, such that only wires 366 and cable 364 pass across an inside surface of base 1114. Lapel clip 384 is positioned into lapel clip notch 1121 and clipped onto base 1114 therein such that lapel clip 384 is also positioned within the periphery of clip 1100. In one embodiment, surface 1113 of base 1114 is recessed to receive one or more of rigid components 368 and 370 to reduce the profile of clip 1100 when wound with earphone set 360.

Additional notch 1107 may receive one or both of wires 366 and cable 364 to shorten one or more turns if repositioning of rigid components 368 and 370 is required. In one embodiment, clip 1100 wound with earphone set 360 has approximate dimensions of 1¾ inch long, 1½ inch wide and ½ inch thick.

In one embodiment, the longest dimension of clip 1100 is not greater than the length of the positioned earpieces 372 or the length of control and microphone 370, and the width of clip 1100 is sufficient to accommodate earpieces 372 and stems 374. Inner segments of each winding notch 1108(1) and 1108(2) are spaced apart a distance determined from the length of wires 366 and cable 364, and the size and position of rigid components 368 and 310. Jack plug 362 may be tucked into position within the periphery of clip 1100 and beneath wires 366 and cable 364.

In one embodiment, a back side of base 1114 is recessed such that one or more rigid components 362, 368, 370 of earphone set 360 may be positioned against rear surface of clip 1100.

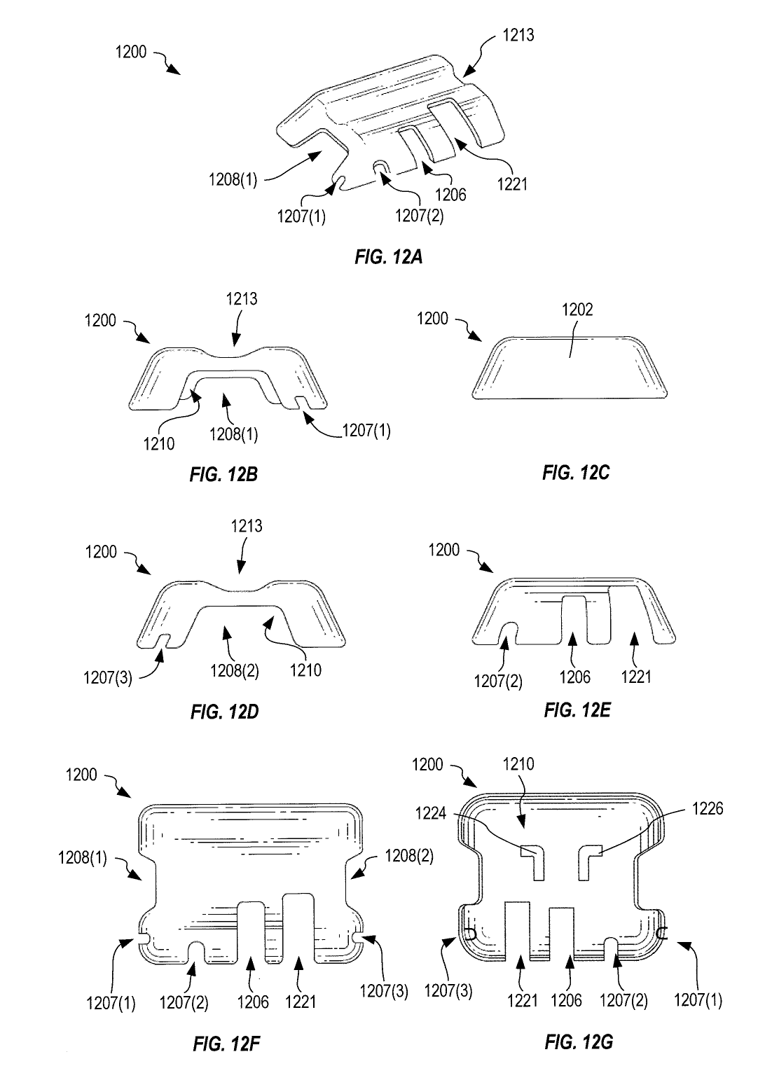

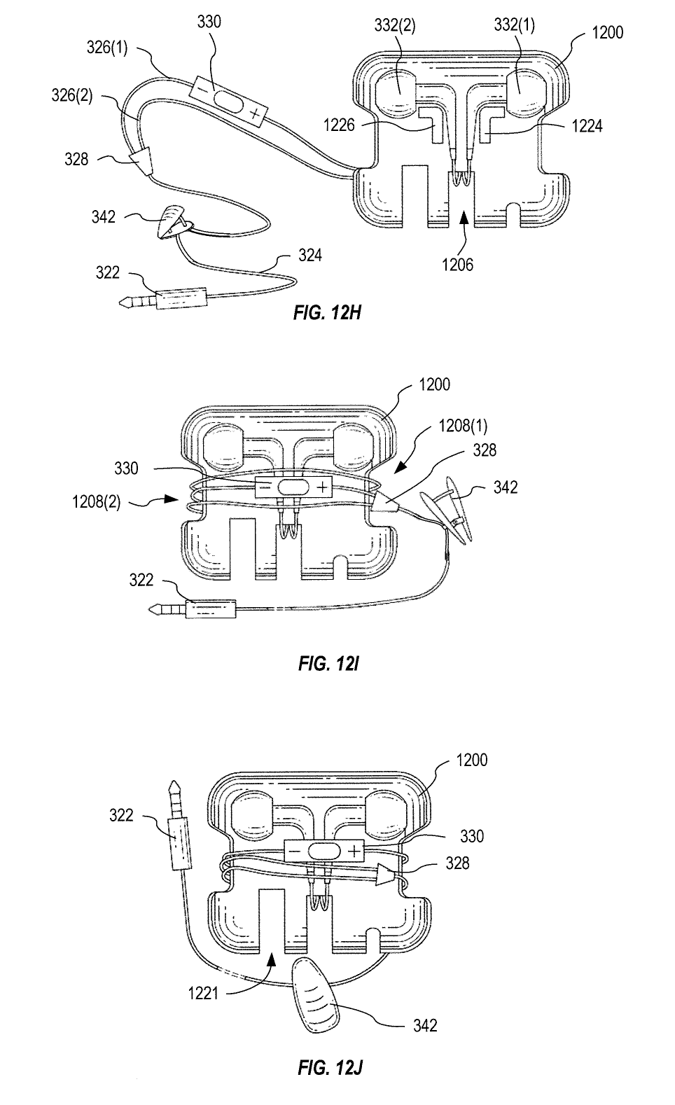

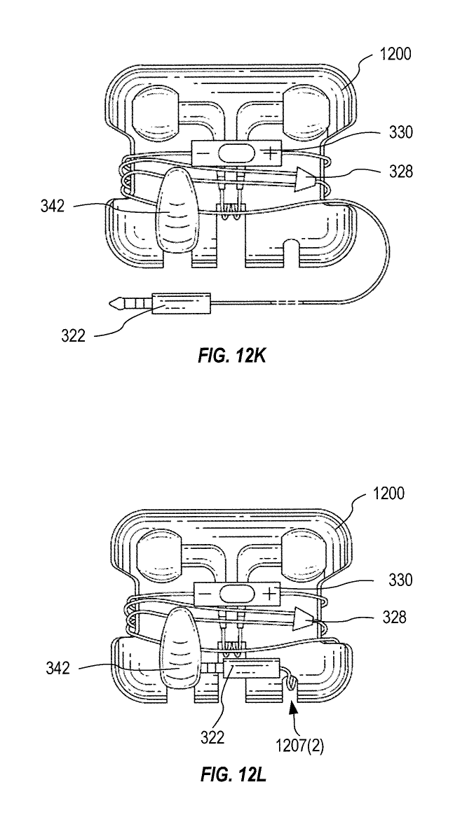

FIGS. 12A-G show one exemplary retaining and protective clip 1200 for retaining in-ear style earphone sets, such as earphone sets 320 and 360 of FIGS. 2, 3 and 4. FIGS. 12H-L shows exemplary winding of earphone set 320 of FIG. 3, configured with lapel clip 342, onto clip 1200 of FIGS. 12A-G.

FIG. 12A is a perspective view of clip 1200 illustrating a shaped design for retaining and protecting the earphone set retained therein. Clip 1200 has an alignment notch 1206, a lapel clip notch 1221, and first and second additional notches 1207(1) and 1207(2). FIG. 12B is a side view of a first side of clip 1200 illustrating an earpiece storage area 1210, a top recess 1213 for reducing height of cables and wires (e.g., wires 326 and cable 324) wound onto clip 1200, and a first winding notch 1208(1). FIG. 12C is a back view of clip 1200 illustrating a protective enclosure 1202 that protects and forms earpiece storage area 1210. FIG. 12D is a side view of a second side of clip 1200 illustrating earpiece storage area 1210, top recess 1213, a third additional notch 1207(3), and a second winding notch 1208(2). FIG. 12E is a front view of clip 1200 illustrating second additional notch 1207(2), alignment notch 1206, and lapel clip notch 1221. FIG. 12F is a top view of clip 1200 illustrating additional notches 1207(1), 1207(2), 1207(3), alignment notch 1206, lapel clip notch 1221, winding notches 1208(1) and 1208(2), and top recess 1213. FIG. 12G is a bottom view of clip 1200 showing two internal inserts 1224 and 1226 for positioning earpieces within clip 1200, as shown in FIG. 12H.

As shown in FIGS. 12A-G, clip 1200 is bowl shaped, thereby having the advantage of providing a more ergonomically pleasing feel when stored within a membrane type container, as described below. In addition, clip 1200 provides a rigid protective housing to protect sensitive components of the earphone set, such as earpieces 332 and remote control and microphone 330.

FIGS. 12H-L show exemplary winding of earphone set 320 of FIG. 3 onto clip 1200. Earpieces 332 are inserted into clip 1200 and wires 326 are passed through alignment notch 1206, as shown in FIG. 12H. Wires 326 and cable 324 are wound around winding notches 1208 such that rigid components 328 and 330 are positioned within a periphery of clip 1200 and lapel clip 342 is clipped into lapel clip notch 1221, as shown in FIGS. 12J-K. Cable 324 may then pass through one of notches 1207 such that jack plug 322 is also positioned within the periphery of clip 1200, as shown in FIG. 12L.

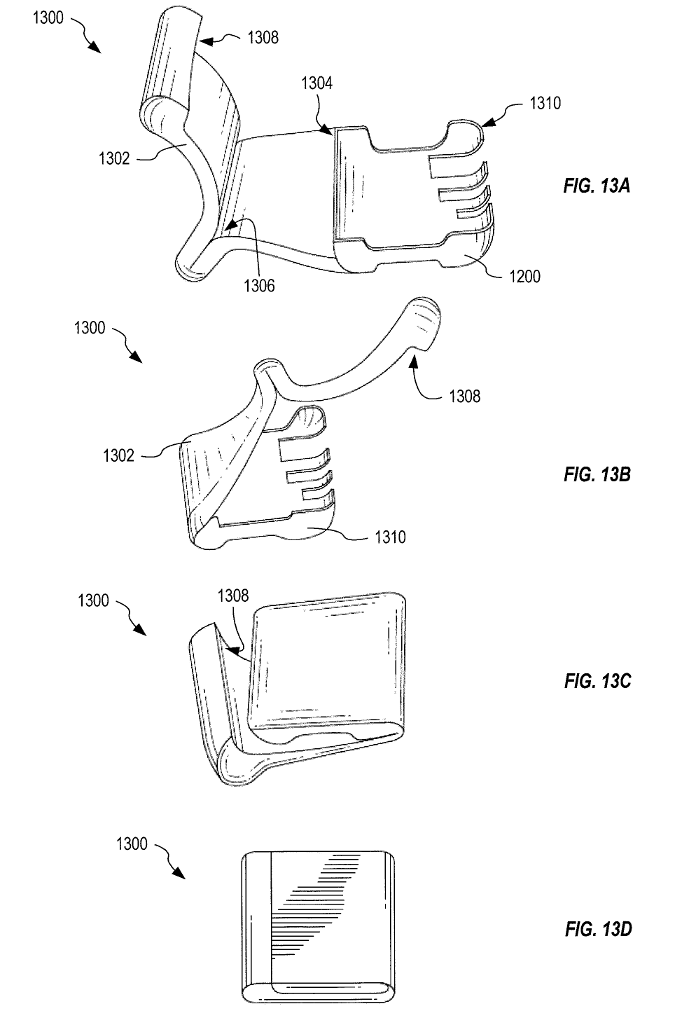

FIGS. 13A-D show an exemplary earphone storage device 1300 formed with clip 1200 of FIGS. 12A-L and a stretchable pouch 1302. Pouch 1302 is attached to an external surface 1304 of earpiece storage area 1210 and is formed with shaped pockets 1306 and 1308 that fit edges 1310 and 1304 of clip 1200 when pouch 1302 is wrapped around clip 1200, as shown in FIGS. 13B-D. Pouch 1302 thereby secures the earphone set within clip 1200 and provides additional protection of the earphone set against damage, such as when carried in a pocket, purse, handbag, briefcase, and so on.

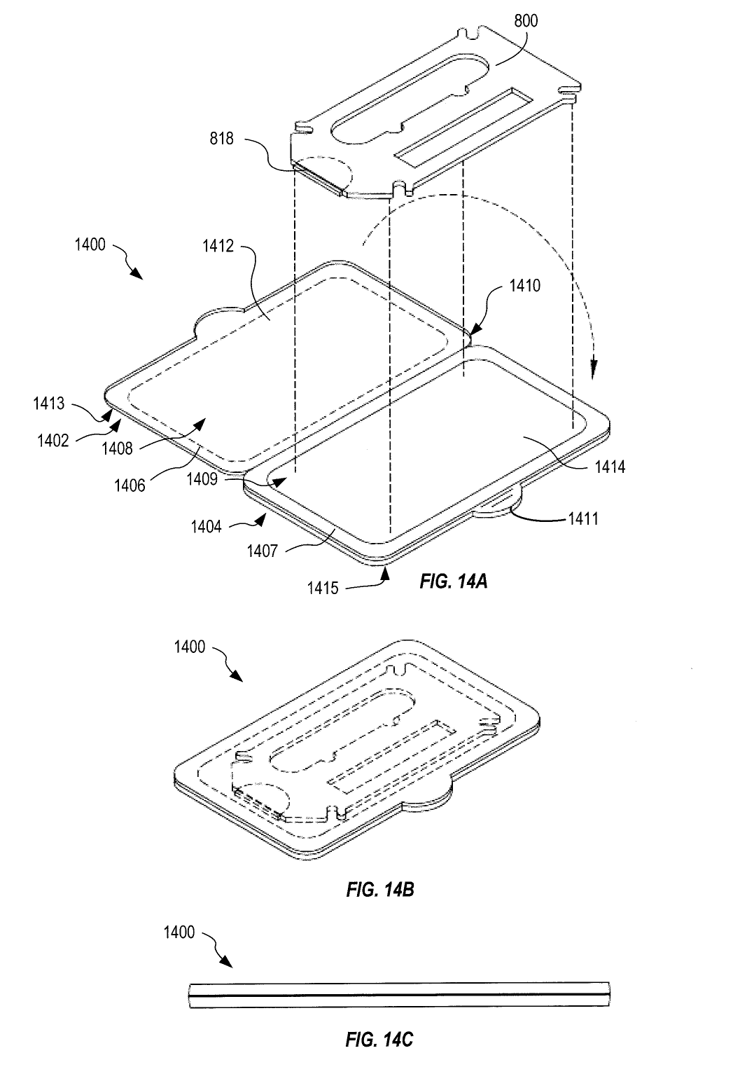

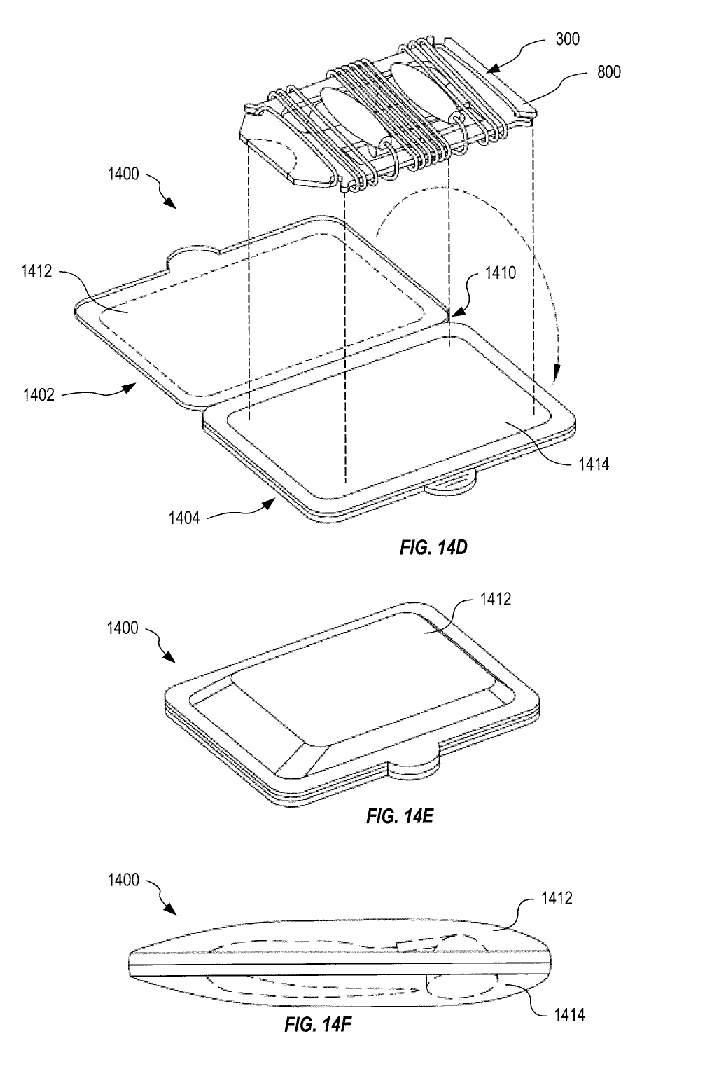

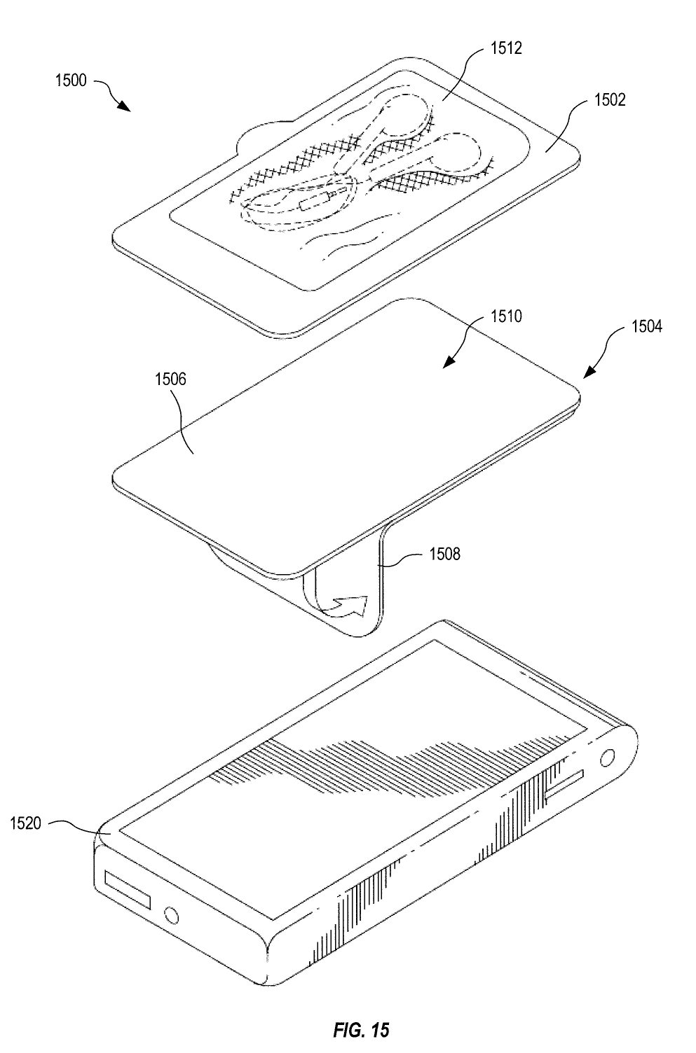

FIGS. 14A-C show an exemplary carrying case 1400 for storing an earphone set (e.g., one of earphone sets 300, 320, 360) wound onto retaining clip 800 of FIGS. 8A and 8B. Carrying case 1400 is formed with a lid component 1402 and a base component 1404 that couple together to form carrying case 1400. Although shown with clip 800, carrying case 1400 may be used to store any of clips 500, 600, 700, 800, 900, 1000, 1100, 1200 of FIGS. 5, 6, 7, 8, 9, 10, 11 and 12, respectively, and may also be used to store other items, such as batteries, note pads, and so on. Carrying case 1400 may also store storage device 1300 of FIG. 13.

Lid component 1402 includes a rectangular former 1406 that has a cutout 1408, and a stretchable material 1412 attached to an outside 1413 of former 1406, wherein former 1406 provides mechanical strength at a periphery of lid component 1402. Similarly, base component 1404 includes a rectangular former 1407 that has a cutout 1409 and a stretchable material 1414 attached along an outside 1415 of former 1407, wherein former 1407 provides mechanical strength to a periphery of base component 1404. Lid component 1402 and base component 1404 are substantially the same shape and size. Lid component 1402 and base component 1404 may each also include one or more protrusions to aid a user in opening carrying case 1400. Stretchable materials 1412 and 1414 are for example made from one or more of Neoprene, Yamamoto Neoprene, “limestone” based neoprenes, woven fabric, pleated fabric, rubber, and other such stretchable materials or materials.

A hinge 1410 joins components 1402 and 1404 along a long edge of each former 1406, 1407 such that lid and base components 1402, 1404 hinge together to form a carrying case, as shown in FIGS. 14B and 14C. Carrying case 1400 may latch closed, using any known latching method that is appropriate for its size, including but not limited to one or more of: a spring and hinge combination, a mechanical catch built into one or both of formers 1406 and 1407, hook and loop fasteners (e.g., Velcro™), and a magnetic fastener coupled with formers 1406 and 1407. Carrying case 1400 may be opened via a catch 1411.

FIG. 14B is a perspective view of carrying case 1400 containing clip 800 and FIG. 14C is a side view of carrying case 1400 containing clip 800. When containing only clip 800, carrying case 1400 is substantially flat, as shown.

FIGS. 14D-F show use of carrying case 1400 of FIGS. 14A-C for storing earphone set 300 of FIG. 1 wrapped onto earphone retaining clip 800 of FIGS. 8A-C, in an embodiment. As shown in FIG. 14D, clip 800 wound with earphone set 300 is placed into opened carrying case 1400, which is then closed, as shown in FIGS. 14E and 14F, wherein stretchable materials 1412 and 1414 are deformed by clip 800 and wound earphone set 300 and clip 800 and earphone set 300 are retained and protected by carrying case 1400.

FIG. 15 shows one exemplary storage case 1500, similar to carrying case 1400 of FIGS. 14A-F, that attaches to a digital media device (DMD) 1520 for storing an earphone set (or other items) together with the DMD. Storage case 1500 includes a lid component 1502 that is substantially the same as lid component 1402 of carrying case 1400 and a base component 1504 that is formed of a substantially rigid sheet 1506 that couples with lid component 1502 to form storage area 1510.

A first side of a double sided adhesive tape 1508 attaches to a bottom side of sheet 1506, and a second side of double sided adhesive tape 1508 may attach directly to a surface (for example, a back surface) of DMD 1520 or to a protective case of DMD 1520. Since sheet 1506 (and the surface of DMD 1520) is substantially rigid, items (e.g., earphone set 300 wrapped onto retaining clip 800) stored within storage case 1500 deform stretchable material 1512 of lid component 1502 when case 1500 is closed around the item.

In one embodiment, hook and loop fasteners are used to couple sheet 1506 with lid component 1502, such that lid component 1502 may be removed from sheet 1506. In another embodiment, a hinge (not shown) couples sheet 1506 to lid component 1502, wherein lid component 1502 includes a clasp mechanism for keeping lid component 1502 closed over sheet 1506.

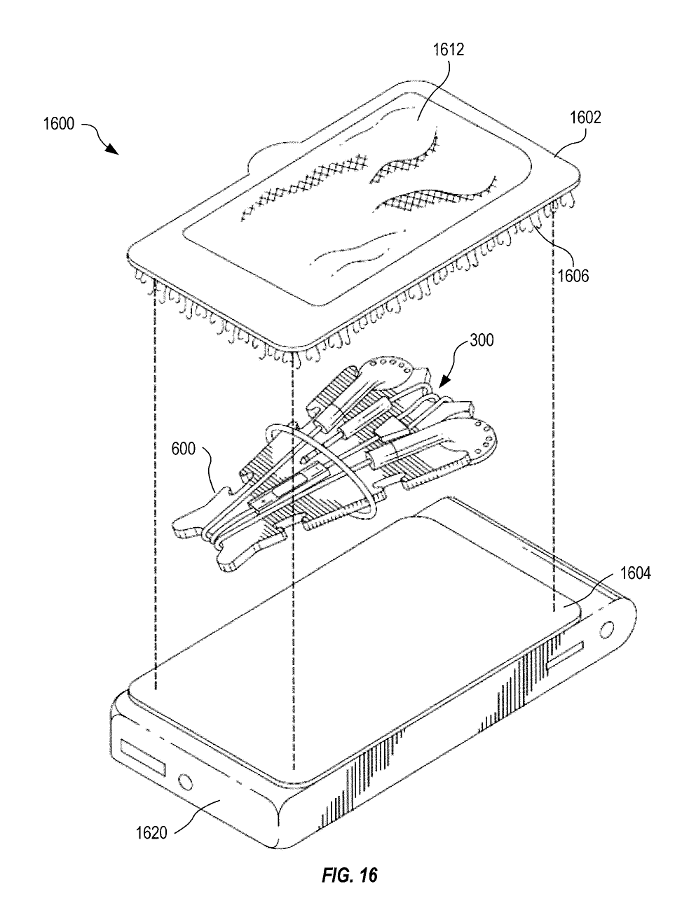

FIG. 16 shows one exemplary storage case 1600 attached to a DMD 1620 by a hook and loop method for storing an earphone set together with the DMD, in an embodiment. Storage case 1600 includes a lid component 1602 that is similar to lid components 1402 of FIGS. 14A-F, and lid component 1502 of FIG. 15, with a hook portion 1606 of a hook and loop fastener attached to the underside (e.g., to an underside of a former similar to former 1406, described above with respect to FIGS. 14A-F). A loop portion 1604 of the hook and loop fastener forms a base component of storage case 1600 and is attached (e.g., by adhesive) to a surface of DMD 1620 (or to a case protecting DMD 1620), as shown.

In one example of use, earphone set 300 of FIG. 1 are wound onto retaining clip 600 and positioned on the base component (e.g., loop portion 1604). Lid component 1602 is then positioned over the earphone set and clip and pressed down such that hook portion 1606 mates with loop portion 1604, where stretchable material 1612 of lid component 1602 is deformed by the earphone set and clip and retained within storage case 1600. To open storage case 1600, the user pulls lid component 1602 away from DMD 1620 such that hook portion 1606 separates from loop portion 1604. Storage case 1600 may be used with other styles of earphone and with other retaining clips without departing from the scope hereof. Further, storage case 1600 may store other items, such as batteries, notebooks, and so on. Storage case 1600 may also store retaining clip 600 when the earphone set is in use.

In one embodiment, loop portion 1604 may be integrated with a protective case of DMD 1620.

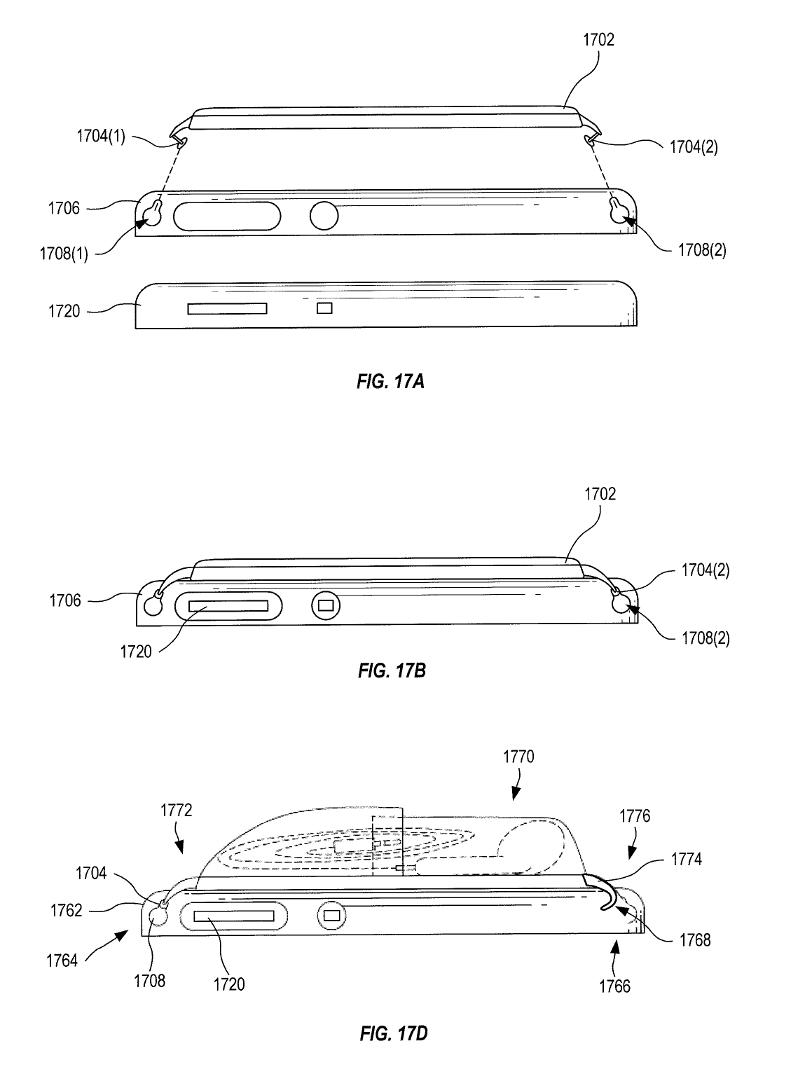

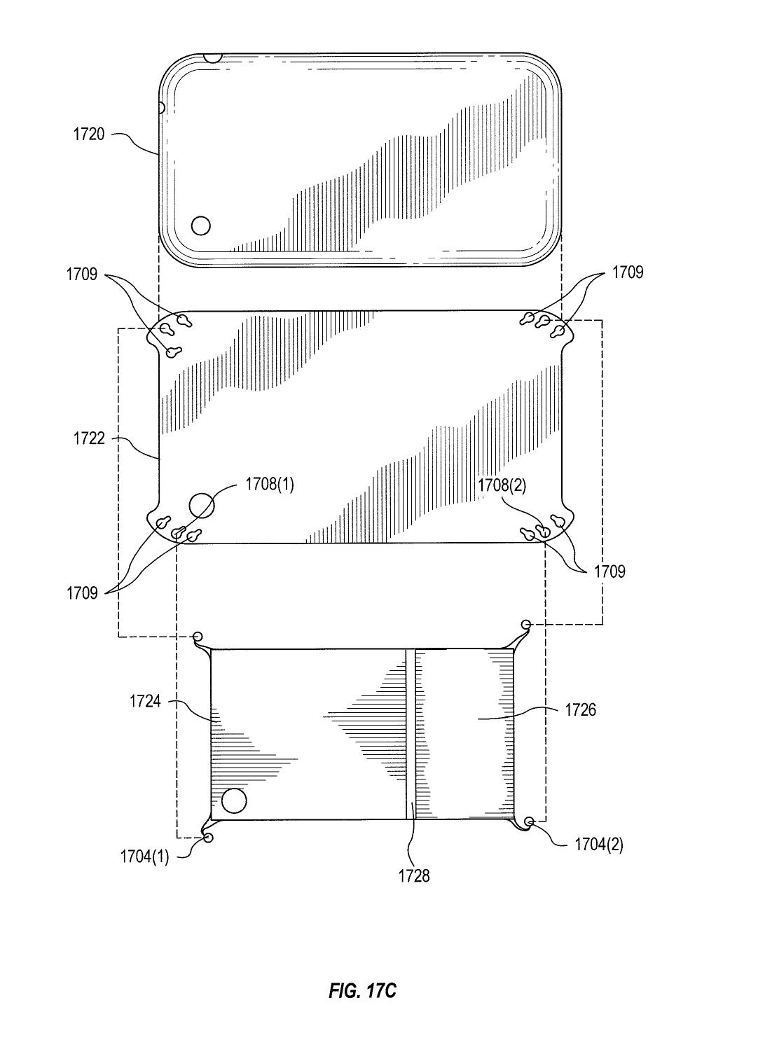

FIGS. 17A-D show one exemplary method of attaching a storage case 1702 to a DMD 1720. Storage case 1702 attaches to a protective DMD case 1706 and may represent any one of storage cases 1500 and 1600 of FIGS. 15 and 16, respectively. That is, storage case 1702 may include features of storage cases 1500 and 1600. Storage case 1702 is configured with a hook 1704 at each of four corners. A protective DMD case 1706 has receptacles 1708, one positioned at each corner of the case, such that when coupled with an associated hook 1704, each storage case 1702 is under tension and hooks 1704 remains within their associated receptacles 1708. Each hook 1704 is formed as a ball or disc at a distal end of a narrower neck. Each receptacle 1708 is formed as a slot with a first end that is sized to allow the ball or disc of hook 1704 to pass and a second end that is smaller than the ball and disc but greater or equal in size to a diameter of the neck of the hook 1704. Each receptacle 1708 is oriented with the second (narrow) end towards the back of protective case 1706 as shown. The neck and/or portions of storage case 1702 may stretch such that hooks 1704 may be inserted into the wide end of their associated receptacles. Storage case 1702 may thereby be easily and securely attached to protective case 1706, as shown in FIG. 17B. Storage case 1702 may also be removed if not needed.

FIG. 17C shows DMD 1720 and a protective case 1722 that is similar to protective case 1706, but is formed with additional receptacles 1709 that allow adjustment of tension on a storage case 1724. Storage case 1724 is formed as a pocket of stretchable material 1726 that has an overlapping opening 1728, as shown. Although opening 1728 is shown vertical across a narrow width dimension of storage case 1724, opening 1728 may have other positions without departing from the scope hereof. Storage case 1724 may include cutouts that allow operation of DMD 1720 without removal of storage case 1724.

FIG. 17D shows an alternate embodiment wherein a first end 1764 of a protective case 1762 is formed with receptacles 1708 as described above, and a second end 1766 formed with a retention slot 1768. A storage case 1770, similar to storage case 1724 of FIG. 17C, is formed with hooks 1704 at a first end 1772, and a retention clip 1774 at a second end 1776. Retention slot 1768 couples with retention clip 1774, for example by lateral sliding, and hooks 1704 couples with receptacles 1708 to removably secure storage case 1770 to protective case 1762.

In the example of FIG. 17D, storage case 1770 is shown as a pocket formed of stretchable material, however, storage case 1770 may represent other storage cases such as storage cases 1500 and 1600, without departing from the scope hereof

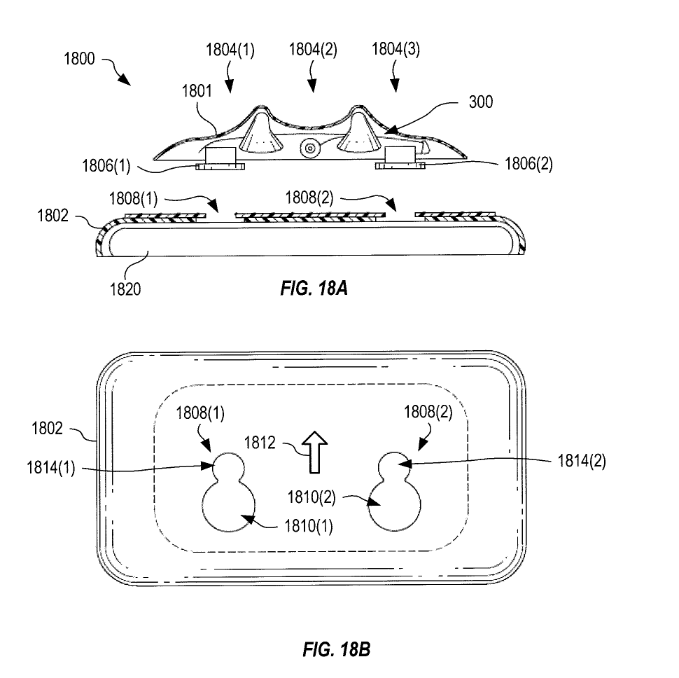

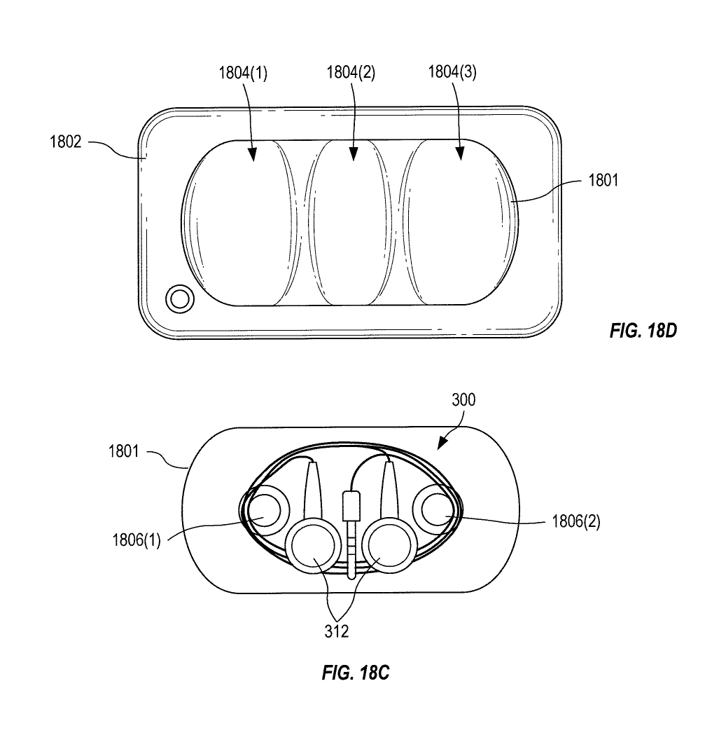

FIGS. 18A-D show one exemplary hard shell carrying case 1800 formed as an earphone storage case 1801 and DMD protection case 1802 that couple together. FIGS. 18A-D are best viewed together with the following description.

Storage case 1801 is substantially hollow and an earphone set (e.g., earphone set 300 of FIG. 3) may be stored therein. The example of FIG. 18A shows earphone set 300 stored within storage case 1801. Storage case 1801 includes two retention posts 1806(1) and 1806(2) that couple with retention slots 1808(1) and 1808(2) of case 1802, respectively. To couple storage case 1801 to case 1802, retention posts 1806 are inserted into receiving areas 1810 of retention slots 1808, and then storage case 1801 is slid laterally in the direction of arrow 1812 such that retention posts 1806 are retained by locking areas 1814 of retention slots 1808. To remove storage case 1801 from case 1802, this process is reversed.

FIG. 18C is a bottom view of storage case 1801 illustrating winding of earphone set 300 around retention posts 1806 such that earphone set 300 are stored within storage case 1801.

Storage case 1801 is ergonomically shaped such that when attached to protection case 1802, DMD 1820 within case 1802 may still be held and operated comfortably by a user. Storage case 1801 has finger grips 1804(1-3) that allow the user to grip DMD 1820, case 1802 and storage case 1801 when combined, with or without an earphone set stored within storage case 1801.

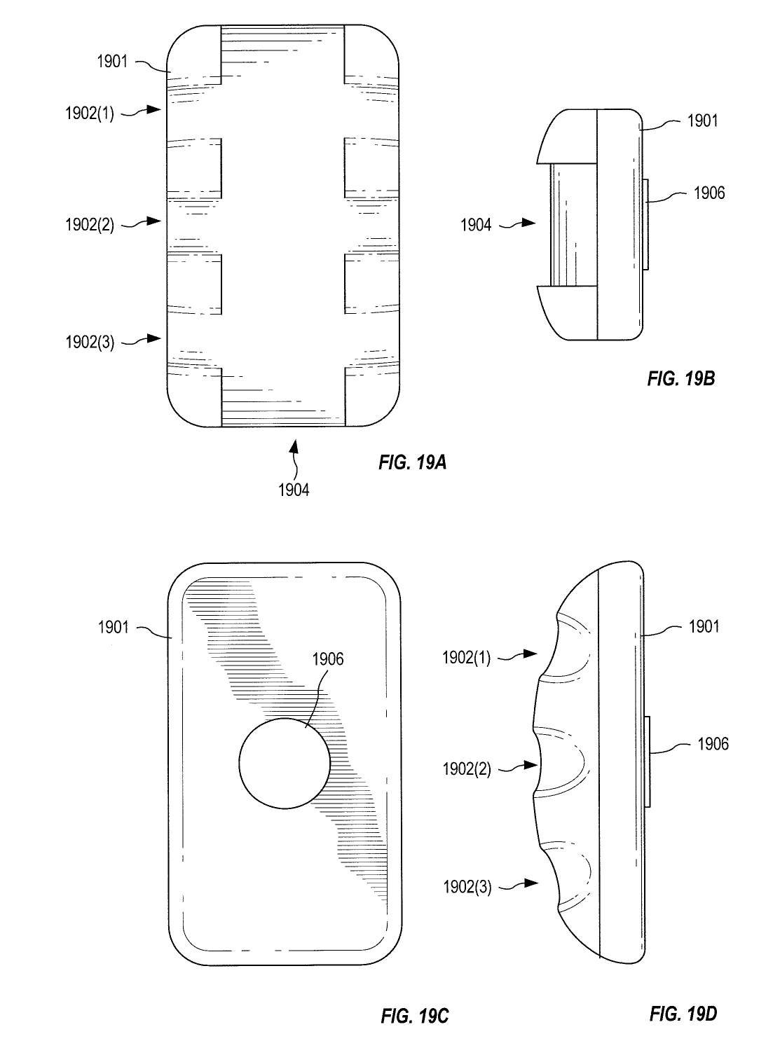

FIGS. 19A-D show one exemplary hard shell carrying case 1901 that is similar to earphone storage case 1801 of FIGS. 18A-D, including finger grips 1902, but formed with a flat slot 1904 across finger grips 1902 to accommodate a hand strap (not shown) as may be used with DMDs (e.g., DMD 1820). Case 1901 may couple with a DMD, or a protective case of the DMD, using coupling means known in the art. In the example of FIG. 19, case 1901 includes a coupling post 1906 that slots into a receptacle formed on the back of a protective case (not shown) of the DMD.

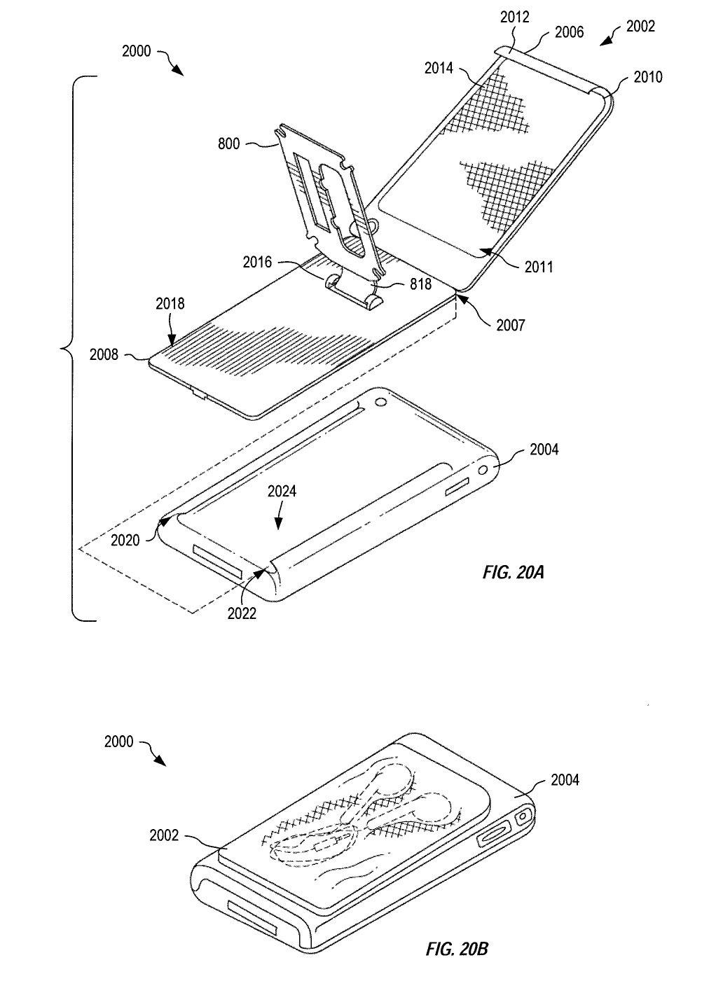

FIGS. 20A and B show one exemplary earphone storage and DMD protection case 2000 with a slide coupling between a storage compartment 2002 and a protective DMD case 2004, and are best viewed together with the following description.

Storage compartment 2002 is formed with a lid component 2006 and a base component 2008. Base component 2008 is a substantially flat and rigid rectangular sheet. Lid component 2006 includes a substantially flat and rigid rectangular former 2010 that may include a latch mechanism 2012. Former 2010 has a cutout 2011 that is covered by a stretchable material 2014. Former 2010 is attached along a short edge to base component 2008 by a hinge 2007. Base component 2008 includes a hinge attachment 2016 on an inside surface 2018 of storage compartment 2002 for attaching to connector 818 of earphone retaining clip 800, FIGS. 8A-C, for example, such that clip 800 is retained within storage compartment 2002. In one embodiment, hinge 2016 is slotted such that clip 800 may detach to facilitate winding of an earphone set onto clip 800.

Protective DMD case 2004 is similar to other protective cases for DMDs, known in the art, but includes two additional slots 2020 and 2022 formed on a back surface 2024. Slots 2020 and 2022 are configured to allow base component 2008 to slide into slots 2020 and 2022 such that storage compartment 2002 removably couples with case 2004, as shown in FIG. 20B.

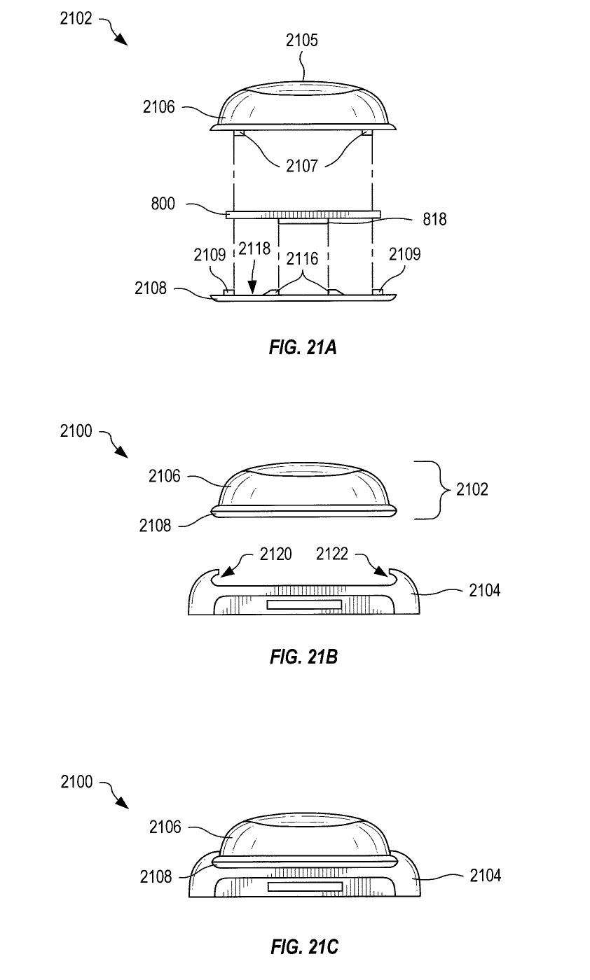

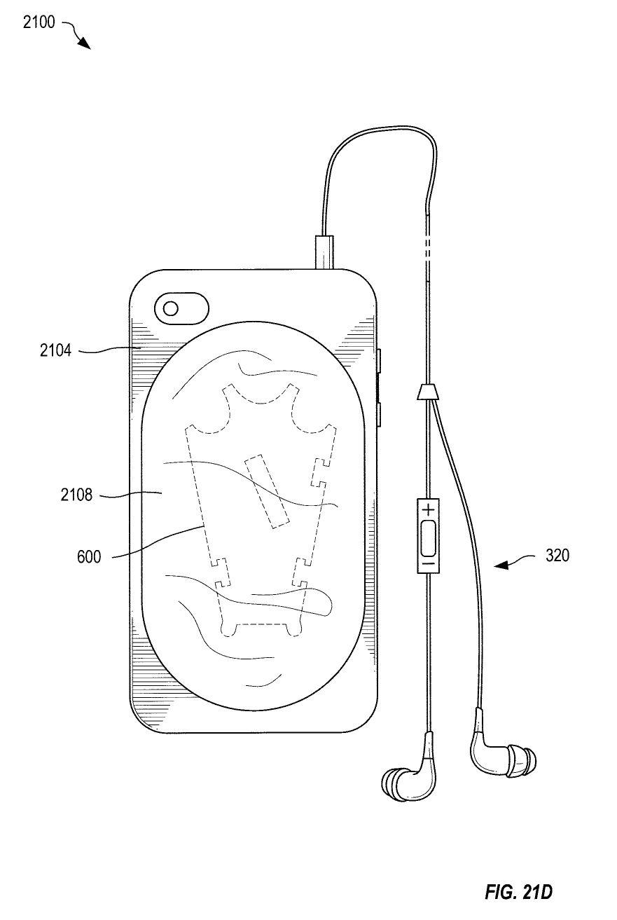

FIGS. 21A-D show one exemplary hard shell earphone storage and DMD protection case 2100 with a slide coupling between a storage compartment 2102 and a protective DMD case 2104.

Storage compartment 2102 is formed with a lid component 2106 and a base component 2108. Base component 2108 is a substantially flat and rigid rectangular sheet. Lid component 2106 is formed as a rigid shell with a plurality of keying features 2107. Lid component 2106 may be formed of two or more pieces that are combined, for example to include a transparent portion 2105 that allows a user to see contents of case 2100 when closed. Base component 2108 includes a plurality of keying features 2109 that mate with keying features 2107 of lid component 2106 as shown in FIG. 21B. Base component 2108 may include a hinge attachment 2116 on an inside surface 2118 of storage compartment 2102 for attaching to connector 818 of earphone retaining clip 800 of FIGS. 8A-C for example, such that clip 800 is retained within storage compartment 2102. In one embodiment, hinge 2116 is slotted such that clip 800 may detach to facilitate winding of the earphone set onto clip 800.

Protective DMD case 2104 is similar to protective DMD case 2004 of FIGS. 20A-B and includes slots 2120 and 2122 configured to allow storage compartment 2102 (i.e., lid component 2106 and base component 2108 couples together) to slide into slots 2120 and 2122 such that storage compartment 2102 removably couples with case 2104, as shown in FIG. 21C. When coupled with case 2104, lid component and base component 2108 are also secured together by slots 2120 and 2122.

FIG. 21D shows hard shell earphone storage and DMD protection case 2100 storing earphone retaining clip 600 of FIG. 6 wherein earphone set 300 are connected to the DMD and ready for use.

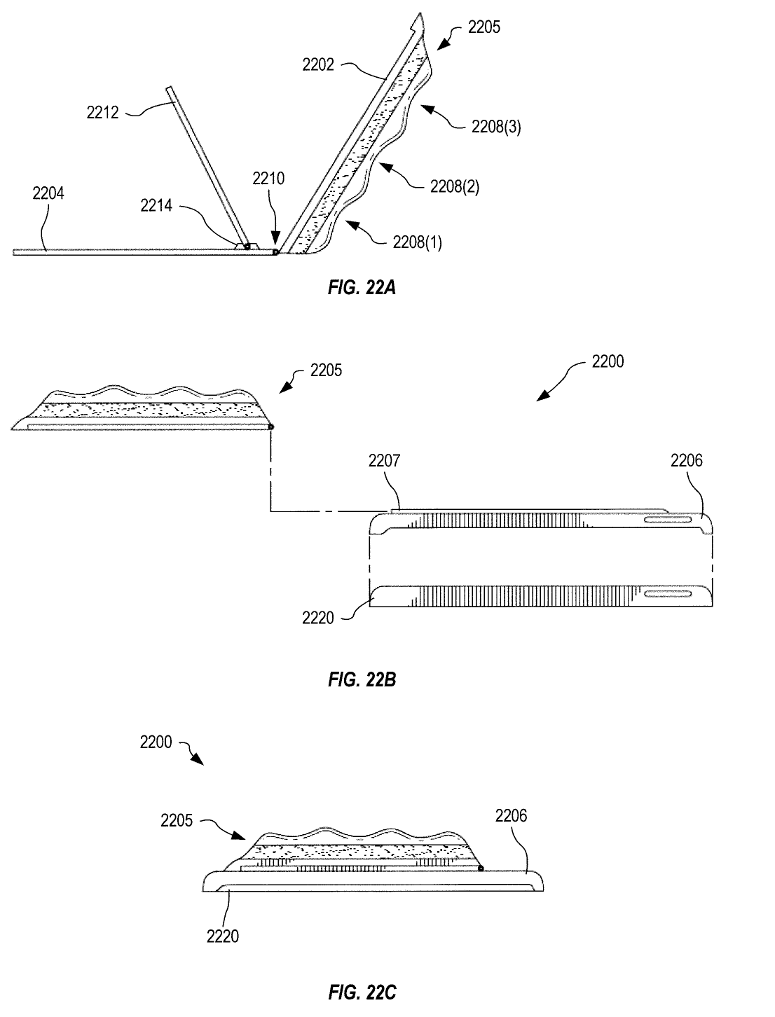

FIGS. 22A-C show one exemplary hard shell earphone storage and DMD protection case 2200 with a slide coupling 2207 between a storage compartment 2205 and a protective DMD case 2206 of a DMD 2220. FIGS. 22A-C are best viewed together with the following description. Storage compartment 2205 includes a lid component 2202 and a base component 2204 that are coupled by a hinge 2210, and a retaining clip 2212 that is coupled with base component 2204 by a hinge 2214. Base component 2204 slides into slide coupling 2207 of protective case 2206 such that storage compartment 2205 removably couples with protective case 2206 and thereby to DMD 2220.

The embodiment of FIGS. 22A-C is similar to the embodiments of FIGS. 20 and 21, except that lid component 2202 is a hard shell formed with finger grips 2208(1-3) that facilitate holding of case 2200, protective case 2206, and DMD 2220, in one hand when coupled together.

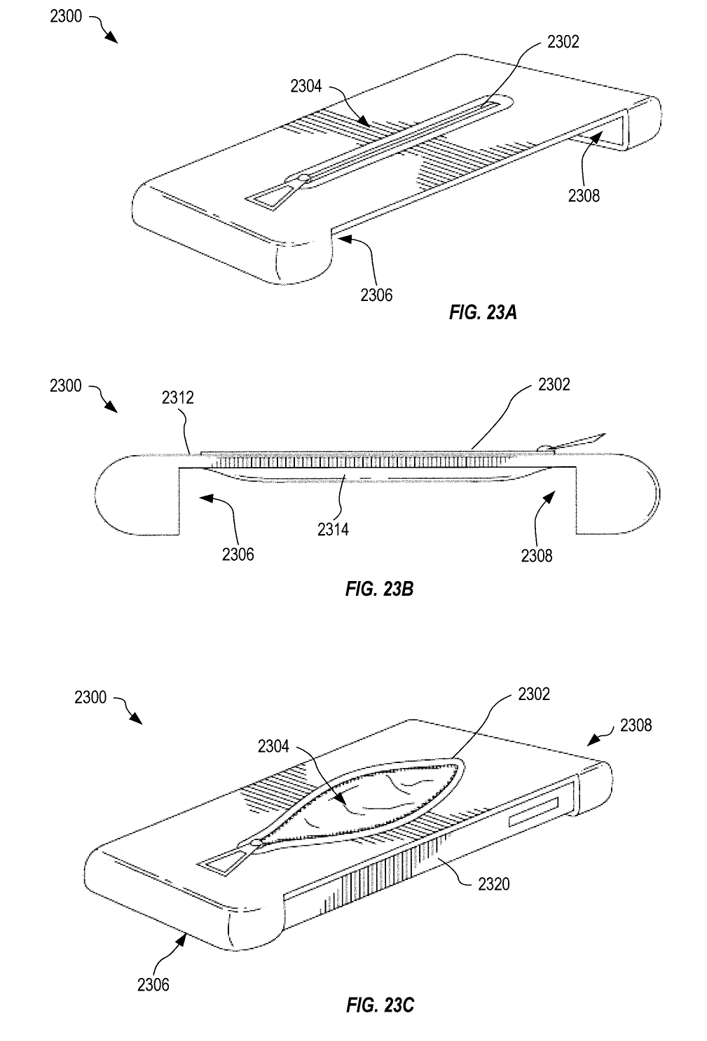

FIGS. 23A-C shows one exemplary zippered storage case 2300 for protecting a DMD and storing accessories, in an embodiment. FIGS. 23A-C are best viewed together with the following description. Storage case 2300 includes a zipper 2302 that provides an opening into a storage area 2304 between a top stretchable material 2312 and a bottom stretchable material 2314 that couple together to form case 2300.

Stretchable material of storage case 2300 is selected from the group including neoprene, Yamamoto neoprene “limestone based”, rubber, elastic, pleated material, and so on. Case 2300 includes first and second external pockets 2306 and 2308 that allow case 2300 to attach to a DMD 2320, as shown in FIG. 23C. In particular, first pocket 2306 and second pocket 2308 may be stretched to fit over opposite ends of DMD 2320 such that DMD 2320 is protected by case 2300. Case 2300 may be easily attached and detached to and from DMD 2320. In one embodiment, storage case 2300 is formed from a single folded sheet of stretchable material that is shaped to form storage area 2304 and pockets 2306 and 2308. In another embodiment, pockets 2306 and 2308 are formed of a more rigid material and conform to the shape of corresponding ends of DMD 2320. In one embodiment, pockets may be split midline, with mid-lengths removed and thus not continuous so as to couple with the DMD at the corners. In another embodiment, corners may be omitted, leaving only a mid-length portion to capture a DMD at the sides and top and bottom, using spring retention built-in to the mid-length or relying on the elasticity of the attached storage compartment to maintain grip of the DMD.

Zipper 2302 allows items to be stored securely within case 2300, whether attached to DMD 2320 or not. Specifically, since case 2300 is fabricated from a stretchable material, storage area 2304 stretches to fit items stored therein. For example, storage area 2304 may be used to store an earphone set (e.g., one of earphone sets 300, 320, 360 of FIGS. 1-4) wound onto one of clips 500, 600, 700, 800, 900, 1000, 1100, 1200, and 2900 of FIGS. 5-12, and 29, respectively. In one example, clips 1000, 1100 and 1200 may be used with case 2300 to provide additional protection for the earphone set wound thereon and stored within storage area 2304. When the earphone set is in use, these clips may be stored within storage area 2304 that remains substantially flat, thereby allowing unimpeded use of DMD 2320.

In one embodiment, zipper 2302 is omitted and an opening is instead formed on an underside 2310 of storage area 2304. At least one of pockets 2306, 2308 is removed from DMD 2320 to access this opening, however when coupled with DMD 2320 (i.e., pockets 2306 and 2308 are positioned on opposite ends of DMD 2320), items are securely stored within storage area 2304.

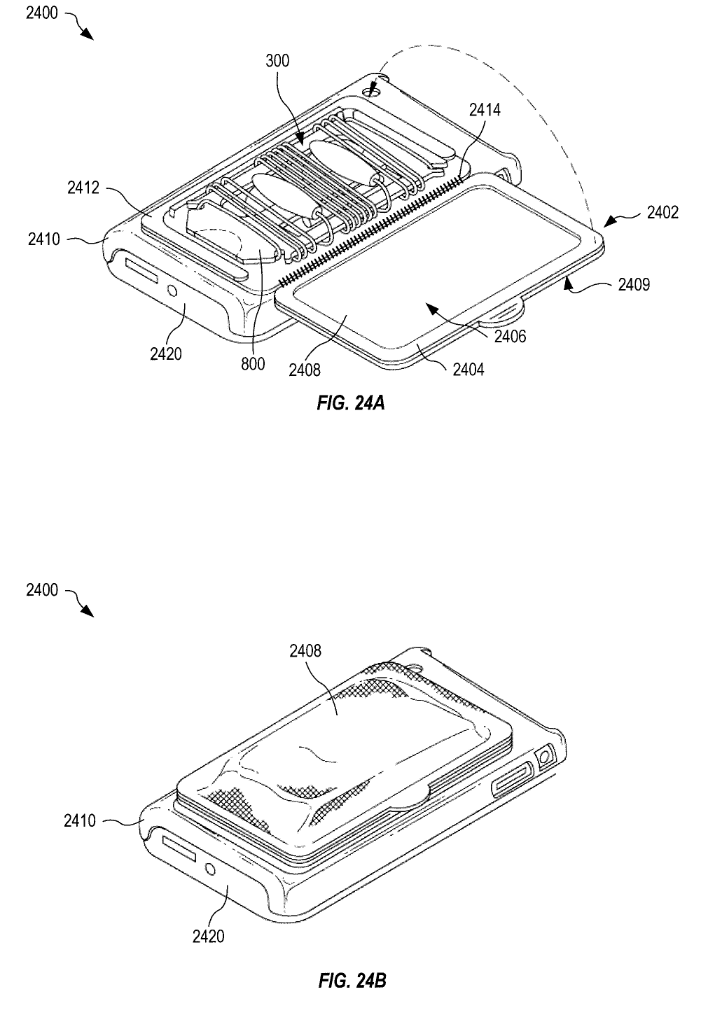

FIGS. 24A and 24B show one exemplary combined earphone storage and DMD protection case 2400. Case 2400 includes a lid component 2402 that is substantially the same as lid component 1402 of FIG. 14; lid component 2402 includes a rectangular former 2404 with a cutout 2406 that is covered by a stretchable material 2408 attached to an external surface 2409 of former 2404. A base component 2410 is formed as a rigid DMD protective case (base component 2410 is shown coupled with a DMD 2420) and includes a seating area 2412 that mates with former 2404 of lid component 2402 when the lid component is closed. Lid component 2402 is attached to base component 2410 by a hinge 2414 that runs along a long edge of former 2404 and base component 2410 as shown. Lid component 2402 and/or base component 2410 may include one or more latching mechanisms, such as a spring and hinge combination, a mechanical catch built into one or both of former 2404 and base component 2410, hook and loop fasteners (e.g., Velcro™) formed on former 2404 and seating area 2412, and a magnetic fastener coupled with former 2404 and seating area 2412, that operates to keep case 2400 closed.

When storing an earphone set wound onto a retaining clip (e.g., earphone set 300 of FIG. 1 wound onto clip 800 of FIG. 8 as shown in FIG. 24A), stretchable material 2408 is deformed when lid component 2402 is closed, as shown in FIG. 24B.

On one embodiment, base component 2410 is molded to receive the earphone set and the earphone retaining clip to facilitate storage of the earphone set and reduce height of the case 2400 when the earphone set is stored therein.

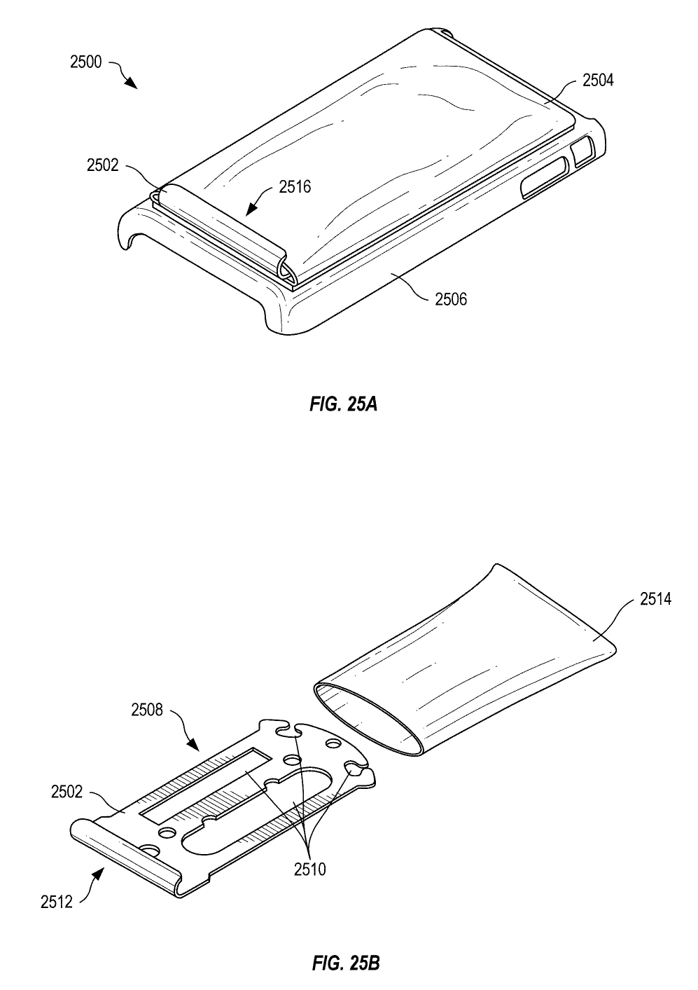

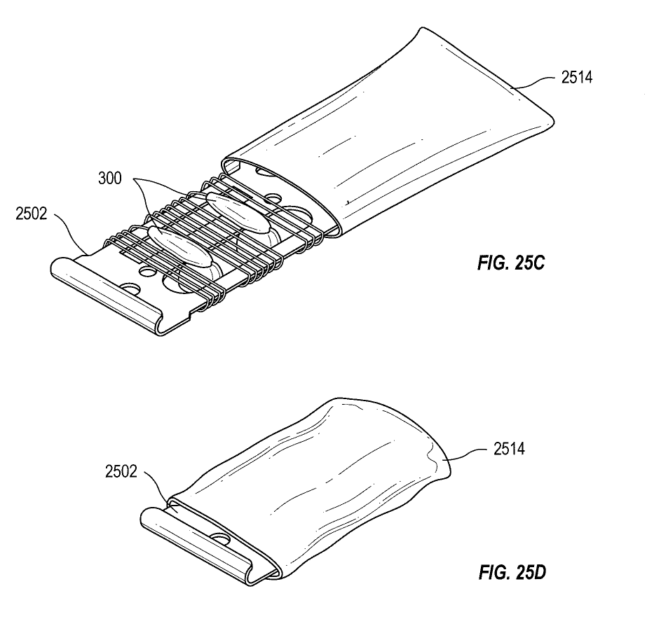

FIGS. 25A-D show one exemplary earphone retaining clip 2502 for use with a stretchable cover 2504 integrated with a DMD protective case 2506. As shown in FIG. 25B, clip 2502 includes a winding area 2508 and a plurality of cutouts and notches 2510 that are similar to features of clip 800 of FIG. 8. Clip 2502 may include other features without departing from the scope hereof. For example, clip 2502 may include an elastic band for retaining pouch 2514 and/or a wound earphone set. Clip 2502 also includes a handle 2512 that facilitate insertion and removal of clip 2502 from a pouch 2514. FIG. 25C shows clip 2502 wound with earphone set 300 of FIG. 1 and partially inserted into pouch 2514. FIG. 25D shows clip 2502 wound with earphone set 300 and fully inserted into pouch 2514. Pouch 2514 may be used together with cover 2504 to facilitate insertion and removal of clip 2502 when wound with an earphone set and to protect the earphone set from friction and abrasion during insertion and extraction. Clip 2502 may also be used with pouch 2514 when not inserted within cover 2504.

Cover 2504 is integrated with case 2506 and has one open end 2516 for insertion of clip 2502 and the stretchable material of cover 2504 securely retains clip 2502 when fully inserted. Cover 2504 is substantially flat when no items are stored within cover 2504 and conforms to a shape of the items when stored. Case 2506 is a rigid structure that is shapes and sized to fit a DMD and provide protection thereto.

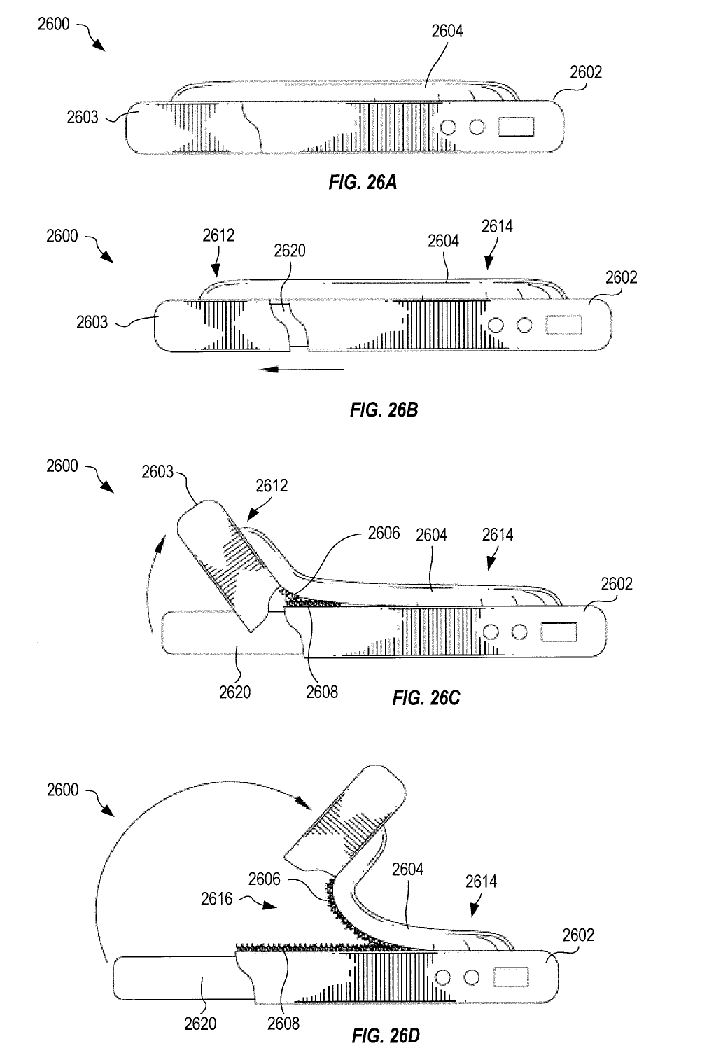

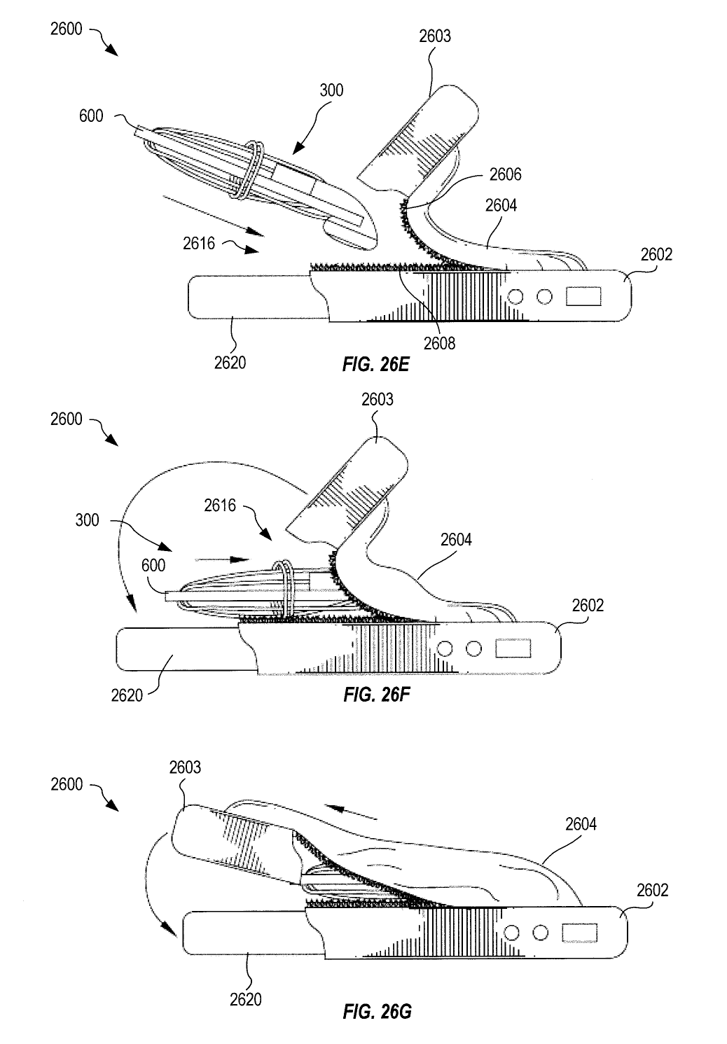

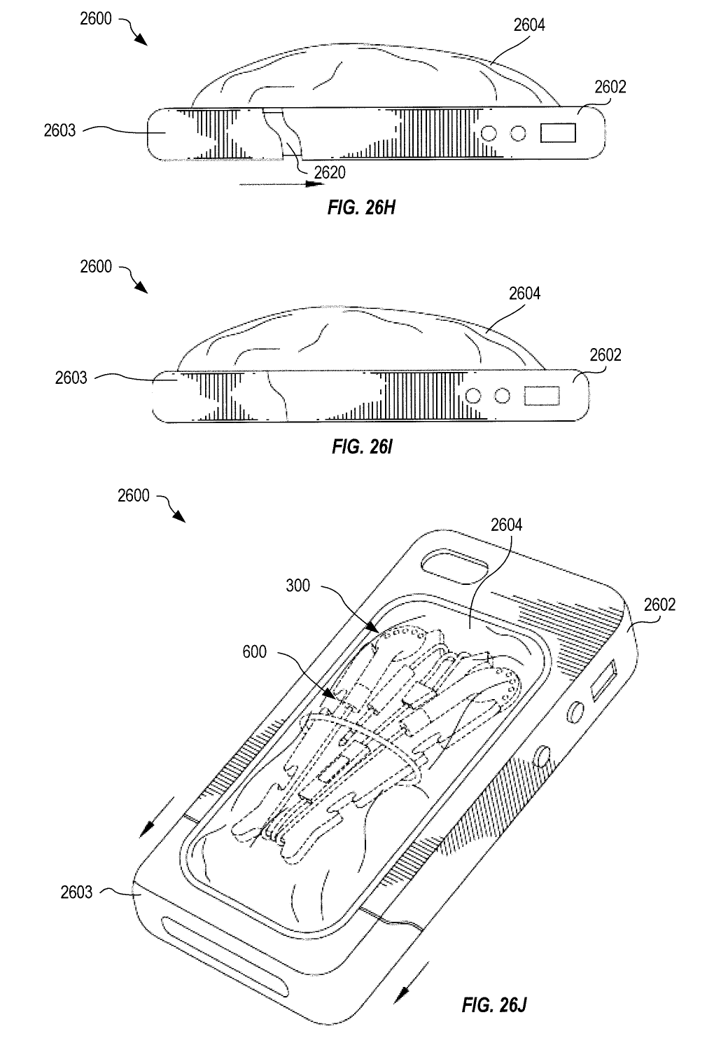

FIGS. 26A-J shows one exemplary split storage and DMD protective case 2600 that protects a DMD 2620 and provides storage for an earphone set (e.g., one of earphone sets 300, 320 and 360 of FIGS. 1-4). FIGS. 26A-J are best viewed together with the following description. Case 2600 includes a DMD protective portion 2602 and a stretchable material 2604 that forms a storage area when case 2600 is coupled with DMD 2620. Material 2604 is fixedly attached to protective portion 2602 at bottom location 2612 and at top location 2614, but not fixedly attached to protective portion 2602 at other locations. In one embodiment, material 2604 is co-molded into protective portion 2602 at locations 2612 and 2614.

As shown in FIGS. 26A-D, protective portion 2602 has a detachable lower portion 2603 that may detach from DMD 2620 without requiring the entire protective portion 2602 to detach. Sides of material 2604 that are not fixedly attached to protective portion 2602 may include other non-permanent attachment means, such as hook 2606 and loop 2608 fastening (as shown), and magnetic fastening. When lower portion 2603 is detached from DMD 2620 and pulled back, as shown in FIG. 26D, hook 2606 detaches from loop 2608 as shown. Material 2604 thereby acts as a hinge between lower portion 2603 and the remaining part of protective portion 2602.

With lower portion 2603 removed from DMD 2620, earphone set 300 wound onto retaining clip 600 of FIG. 6 may be inserted into a storage area 2616 of case 2600, as shown in FIGS. 26E-F. Once the earphone set is inserted into storage area 2616, lower portion 2603 may be refitted to DMD 2620, wherein material 2604 is stretched over earphone set 300 and clip 600 as shown in FIGS. 26G-J. Material 2604 also operates to retain protective portion 2602 onto DMD 2620.

As shown in FIG. 26I, stored earphone set 300 and retaining clip 600 results in a rounded shape 2618 that fits ergonomically within the palm of a hand holding DMD 2620, and does not inhibit operation of DMD 2620. FIG. 26J is a perspective view showing storage of earphone set 300 and clip 600 within case 2600.

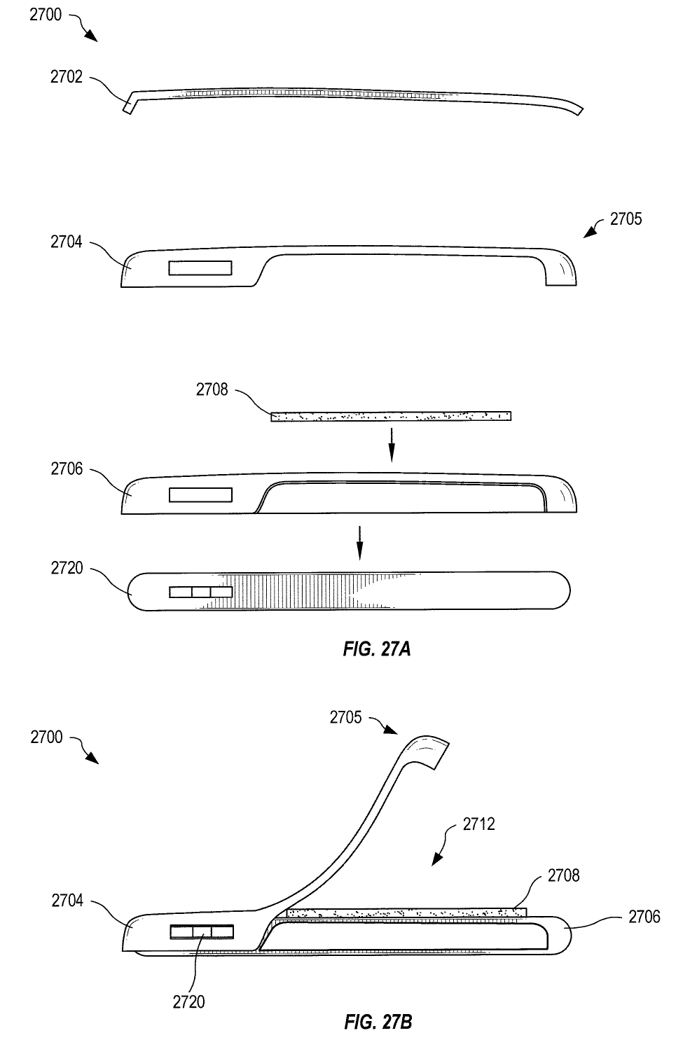

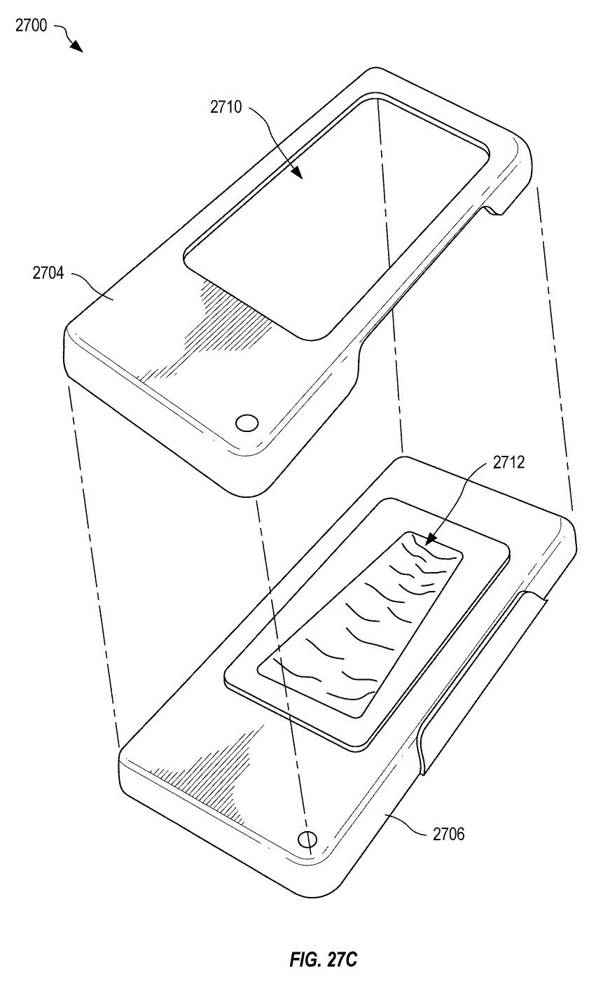

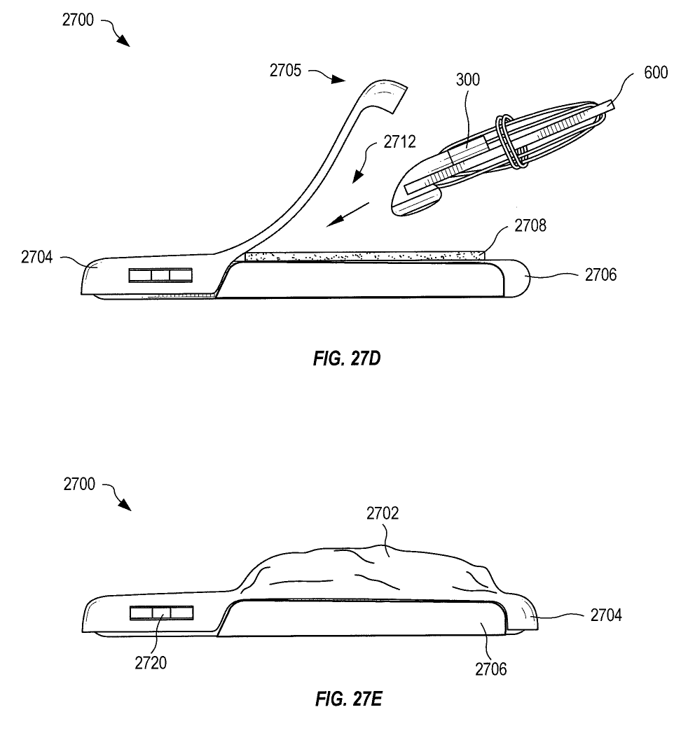

FIGS. 27A-E show one exemplary sprung storage and protective case 2700 for a DMD, in an embodiment. FIG. 27A is an exploded view showing a stretchable material 2702, a spring portion 2704, a base portion 2706, and an optional foam bed 2708 that couple together to form case 2700 that protects a DMD 2720, as shown in FIG. 27B. Stretchable material 2702 fixedly attaches to an inside surface of spring portion 2704 and is for example made from one of oil based neoprene or limestone based neoprene such as Yamamoto neoprene, or other elastic material. In one embodiment, material 2702 covers an outer surface of spring portion 2704. In anther embodiment, material 2702 is co-molded with spring portion 2704.

Spring portion 2704 is made from a semi-rigid spring like material that allows a first end 2705 to be pulled back as shown in FIG. 27B. First end 2705 may also include a latch mechanism that latches end 2705 of spring portion 2704 to base portion 2706. Spring portion 2704 is fixedly attached to base portion 2706 at a second end 2707.

FIG. 27C is a perspective view showing spring portion 2704 positioned to couple with base portion 2706. Although not shown for clarity of illustration, material 2702 is located within an aperture 2710 within spring portion 2704. FIG. 27D shows exemplary earphone set 300 of FIG. 1 and retaining clip 600 of FIG. 6 being inserted into storage area 2712. Once items are inserted into storage area 2712, end 2705 of spring portion 2704 is closed (and optionally latched) with base portion 2706, wherein material 2702 is deformed by earphone set 300 and clip 600, as shown in FIG. 27E.

Items of any reasonable size may be stored within storage area 2712, wherein material 2702 extends only as much as needed to accommodate the stored item. Further, material 2702 and storage area 2712 are ergonomically positioned such that DMD 2720 may still be comfortably used when storing earphone set 300 and clip 600 for example. In particular, items within storage area 2712 are positioned within a palm of a hand when DMD 2720 is held for normal operation, and thereby do not restrict operation of DMD 2720.

In one embodiment, foam bed 2708 is shaped to receive earphone set 300 and clip 600 thereby providing a more secure and protective storage environment.

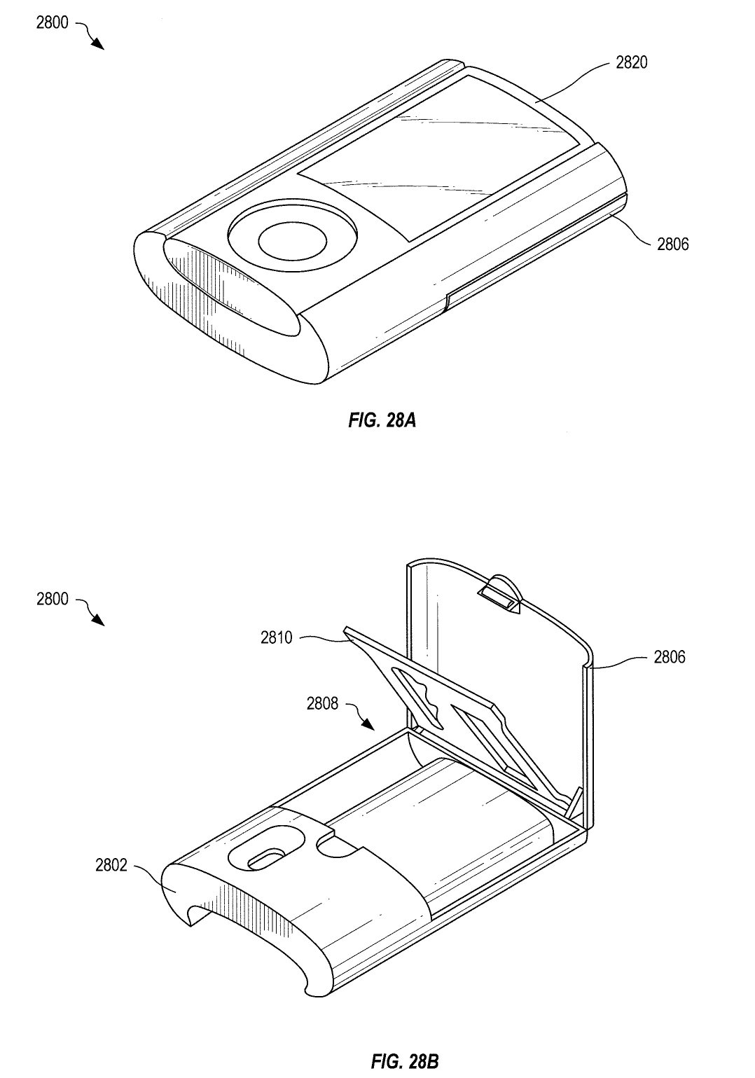

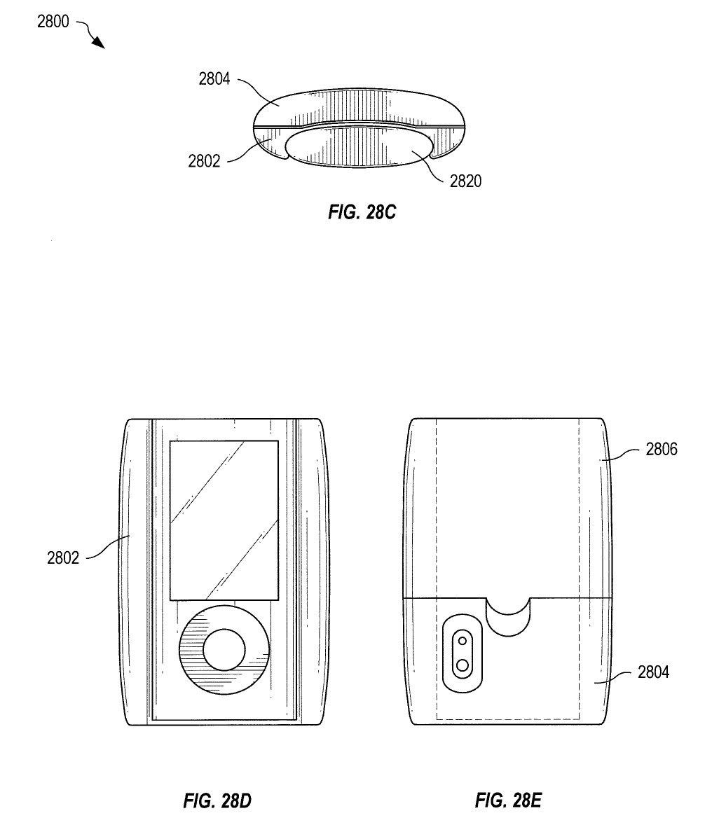

FIGS. 28A-E show one exemplary integrated hard storage and protective case 2800. FIGS. 28A and 28C show a DMD 2820 inserted into case 2800 that is shaped and sized to receive DMD 2820. As shown in FIG. 28C, case 2800 is formed with a front section 2802 that couples with DMD 2820 and a storage section 2804 that includes a door 2806 that provides access to a storage area 2808. Storage area 2808 includes a retaining clip 2810 that is similar to clips 500, 600, 700, 800, 900 of FIGS. 5-9, respectively, and further includes a hinge point for pivotally attaching within storage area 2808. In one embodiment, retaining clip 2810 is removable to facilitate winding of an earphone set (e.g., one of earphone sets 300, 320, and 360 of FIGS. 1-4). Although storage area 2808 may be used to store the earphone set without using clip 2810, clip 2810 allows the earphone set to be tidily wound and inserted into storage area 2808 without damage, as may result when door 2806 is closed with one or both of wires 306 and cable 304 not fully inserted. Further, the use of clip 2810 prevents movement of the earphone set within storage area 2808 when case 2800 is transported (e.g., within a pocket or bag).

Case 2800 is ergonomically designed to position itself within a palm of the user's hand during use. By combining storage with DMD protection, case 2800 proves enhanced utility.

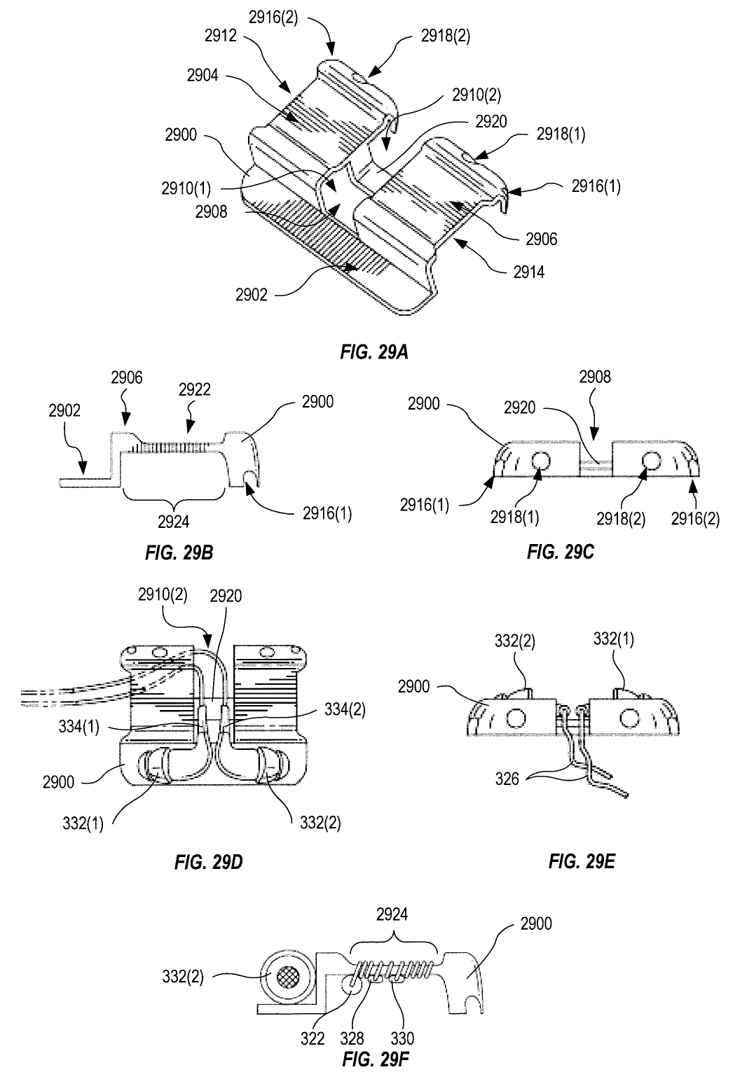

FIGS. 29A-C show one exemplary shaped earphone retaining clip 2900 for retaining an in-ear style earphone set using reduced height. FIGS. 29D-F show exemplary winding of earphone set 320 of FIG. 2 onto clip 2900 of FIGS. 29A-C. FIGS. 29A-F are best viewed together with the following description.

Clip 2900 has a flat area for receiving earpieces 332 of earphone set 300, as shown in FIG. 29D. Clip 2900 has a first raised portion 2904 and a second raised portion 2906 with a valley 2908 therebetween. Valley 2908 has first and second cutouts 2910(1) and 2910(2) leaving a stem support 2920. First raised portion 2904 has a cutout 2912 and second raised portion 2906 has a cutout 2914 that together form a winding area 2924. Optionally, clip 2900 may have one or more additional notches 2916 for changing a winding length of cable 324 and wires 326 around winding area 2924 to position rigid components of earphone set 320 beneath raised portions 2904 and 2906. Optionally, clip 2900 may have one or more holes 2918 for securing jack plug 322.

As shown in FIGS. 29D-F, earphone set 320 may be retained by clip 2900 such that rigid components 322, 328, 330, and 332 and stored within a periphery of the clip, and such that space utilized by clip 2900, when retaining earphone set 320 for example, is minimal. Clip 2900 may be used with one or more of storage cases 1400, 1500, 1600, 2000, 2100, 2200, 2300, 2400, 2500, 2600, 2700, and 3200 of FIGS. 14, 15, 16, 20, 21, 22, 23, 24, 25, 26, 27 and 32, respectively.

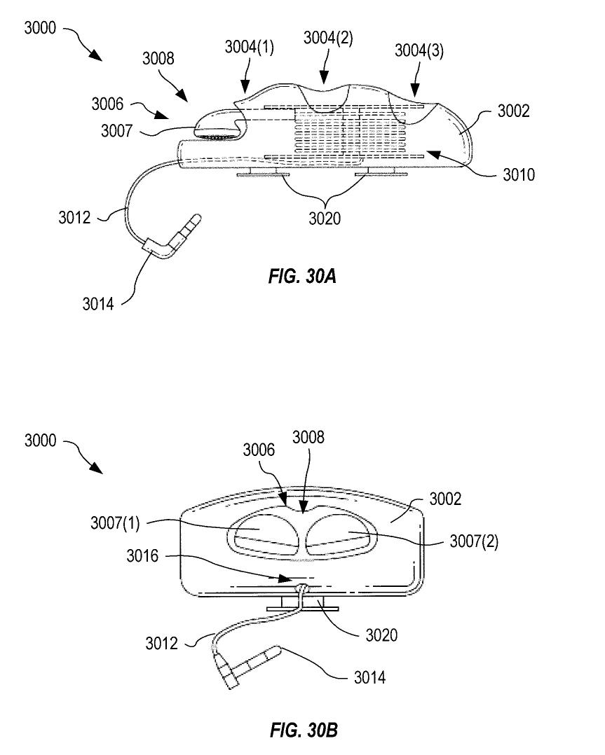

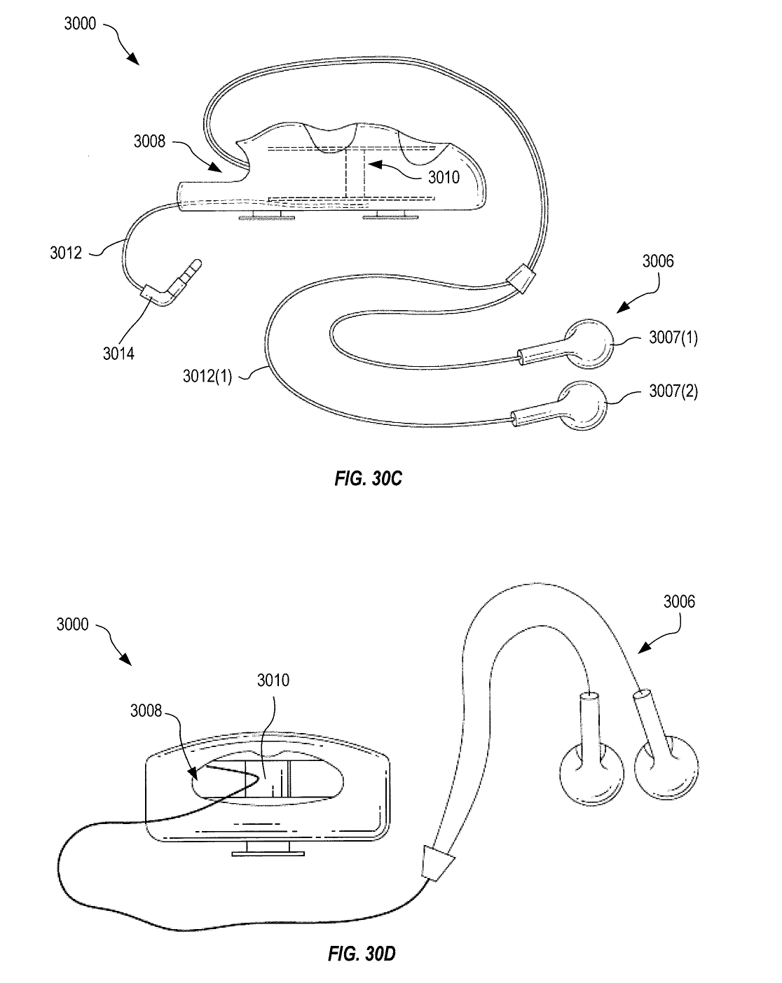

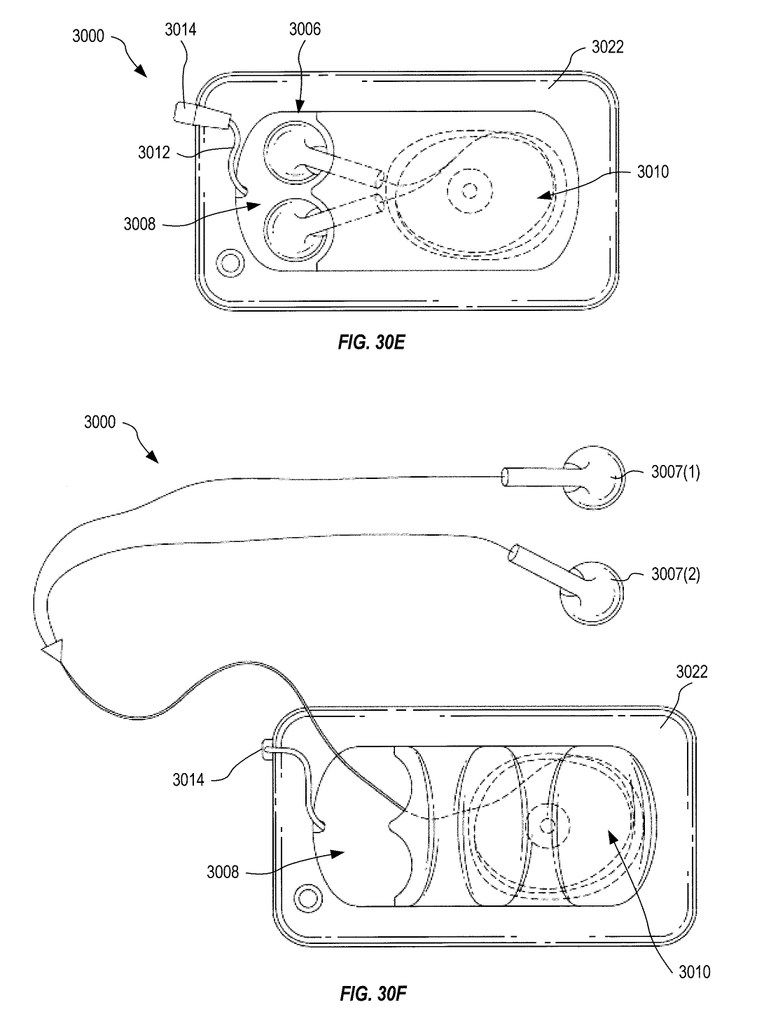

FIGS. 30A-F shows a retractable earphone set in one exemplary storage case 3000 that attaches to a protective case (not shown) of a DMD. FIGS. 30A-F are best viewed together with the following description.

Storage case 3000 has a hard shell 3002 that is ergonomically styled with finger grips 3004(1-3) for protecting earphone set 3006 when wound onto a retractable mechanism 3010. Case 3000 has an opening 3008 within which earpieces 3007 are stored when earphone set 3006 are retracted, and from which earpieces and wires of earphone set 3006 may be withdrawn. In one embodiment, a cable 3012 and a jack plug 3014 of earphone set 3006 extend through a hole 3016 of case 3000 such that jack plug 3014 may be inserted into a jack socket of a DMD to which case 3000 is attached. In another embodiment, cable 3012 and jack plug 3014 are stored within case 3000 and may extend through opening 3008 as shown in FIG. 30D. Case 3000 provides convenient storage of earphone set 3006 proximate the DMD to which case 3000 is attached.

FIG. 30E shows case 3000 coupled with a protective DMD case 3022, with earphone set 3006 retracted and jack plug 3014 couples with a DMD within protective DMD case 3022. Case 3000 has two exemplary coupling posts 3020, as shown in FIGS. 30A and 30B, for coupling with retaining slots of protective DMD case 3022. However, other means of coupling (e.g., hook and loop, magnetic, double sided adhesive tape, and so on) may be used to attach case 3000 to the protective DMD case, or to the DMD itself, without departing from the scope hereof

FIG. 30F shows case 3000 coupled with protective DMD case 3022, with jack plug 3014 couples with a DMD within protective DMD case 3022, and with earphone set 3006 extracted and ready for use.

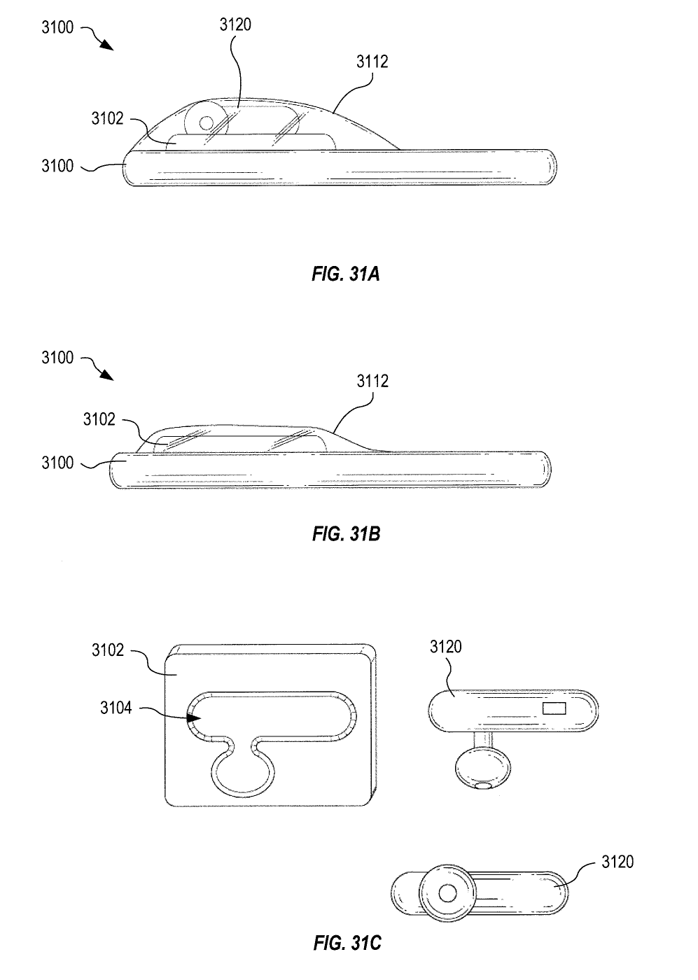

FIGS. 31A and 31B show one exemplary storage case 3100 for storing a Bluetooth earpiece 3120. Case 3100 may represent any one of cases 1500, 1600, 2300, 2400, and 2600, of FIGS. 15, 16, 23, 24, and 26, respectively, and further includes a foam former 3102 that is positioned within storage case 3100 and shaped to receive and protect Bluetooth earpiece 3120. Earpiece 3120 is held in place by a stretchable material 3112 of case 3100. Foam former 3102 may remain within storage case 3100 when earpiece 3120 is removed. FIG. 31C shows foam former 3102 of storage case 3100 of FIGS. 31A and 31B with a cutout 3104 shaped to receive earpiece 3120.

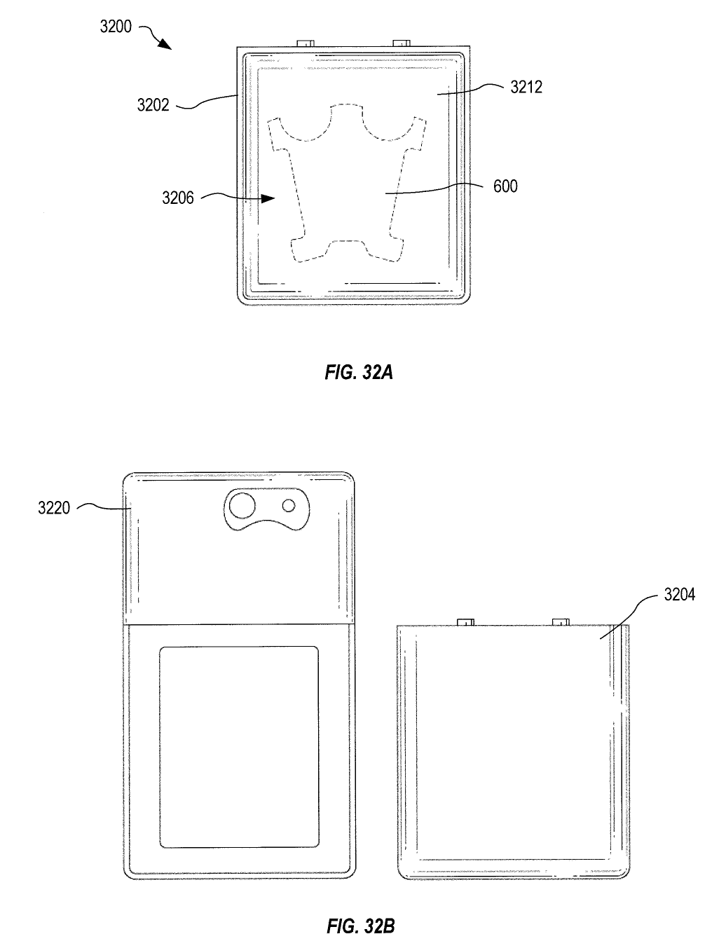

FIGS. 32A and 32B show one exemplary storage case 3200 configured to replace a battery compartment cover 3204 of a DMD 3220. Case 3200 includes a base portion 3202 that is shaped and sized substantially the same as original battery compartment cover 3204 of a DMD 3220, and a stretchable material cover 3212 that together with base portion 3202 forms a storage area 3206 between base portion 3202 and material 3212. Material 3212 may be removably attached to base portion 3202 by one or more of hook and loop fasteners, magnets, hooks, and so on, or may include an opening, to allow access to storage area 3206. Case 3200 is shown storing clip 600 of FIG. 6, but may store other items including earphone set 300 of FIG. 1 wound onto one of clips 700, 800, 900, of FIGS. 7, 8, and 9, and earphone set 320 or 360 wound onto one of clips 500, 1000, 1100, and 1200 of FIGS. 5, 10, 11, and 12, respectively, and may store storage device 1300 of FIG. 13.

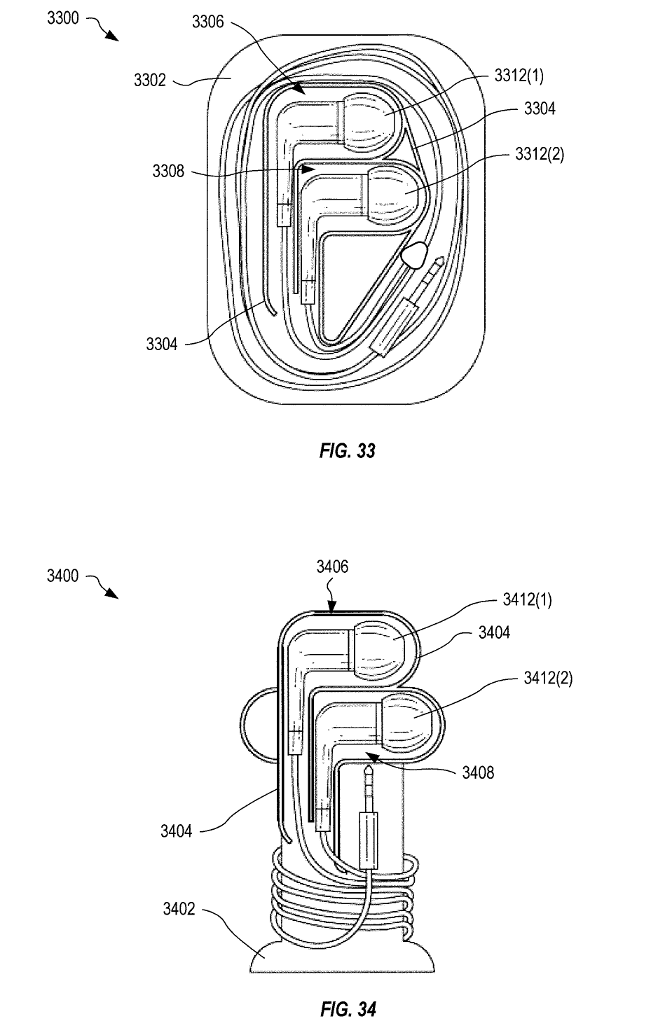

FIG. 33 is a top view of one exemplary earphone set storage clip 3300 formed with a base portion 3302 that is substantially flat and a raised former 3304 that has recesses 3306 and 3308 that are sized and shaped to receive earpieces 3312(1) and 3312(2) of an earphone set. Earpieces 3312 may represent any of earpieces 312, 332, and 372 of earphone sets 300, 320 and 360 of FIGS. 1, 2 and 4, respectively. Clip 3300 may be used where space available for storing the earphone set is not restricted in size, such as with larger DMDs.

Storage cases 1400, 1500, 1600, 2000, 2100, 2200, 2300, 2400, 2500, 2600, 2700, and 3200 of FIGS. 14, 15, 16, 20, 21, 22, 23, 24, 25, 26, 27 and 32, may include one or more cutouts that allow operation of features (e.g., camera) of the DMD without requiring decoupling of the storage case from the DMD.

FIG. 34 is a top view of one exemplary earphone set storage clip 3400 formed with a base portion 3402 that is substantially flat and a raised former 3404 that has recesses 3406 and 3408 that are sized and shaped to receive earpieces 3412(1) and 3412(2) of an earphone set. Earpieces 3412 may represent any of earpieces 312, 332, and 372 of earphone sets 300, 320 and 360 of FIGS. 1, 2 and 4, respectively. Clip 3400 may be used where space available for storing the earphone set is restricted in width, such as with narrow DMDs.

In one embodiment, a retaining clip securely captures and stores an earphone set including two ear-pieces, a length of cable divided into two wires at a junction splitter, each wire coupled with a different one of the ear-pieces, one of the wires having an inline control panel, an undivided end of the cable coupled to a jack plug. The retaining clip has a ring shaped (open center) that is sized to securely capture the earphone set, the ring has at least one bend, undulation, or indentation sized to receive the two ear-pieces, and a pair of winding notches configured with a distance between inner segments that allow for winding the two wires such that the inline control panel and the junction are positioned within a periphery of the retaining clip. The jack plug is retained within the periphery by one or both of the wires and the cable.

101571 Changes may be made in the above methods and systems without departing from the scope hereof. For example, features of earphone retaining clips 500, 600, 700, 800, 900, 1000, 1100, 1200, and 2900 of FIGS. 5, 6, 7, 8, 9, 10, 11, 12, and 29, respectively, may be interchanges as appropriate for particular earphone styles, without departing from the scope hereof. Similarly, features of storage cases 1400, 1500, 1600, 2000, 2100, 2200, 2300, 2400, 2500, 2600, 2700, and 3200 of FIGS. 14, 15, 16, 20, 21, 22, 23, 24, 25, 26, 27 and 32, respectively, may be interchanged as appropriate for storing particular earphone styles and for coupling with particular DMDs, without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. A retaining clip for securely capturing and storing an earphone set comprising two ear-pieces, a length of cable divided into two wires at a junction splitter, wherein each of the wires is coupled to a different one of the ear-pieces and one of the wires has an inline control panel coupled thereto, and wherein an undivided end of the cable is coupled to a jack plug, the retaining clip comprising:
a plate shaped and sized to securely capture the earphone set comprising:
a first cutout sized to receive the two ear-pieces; and
a first pair of notches, disposed on opposite edges of the plate, about which the two wires are wound, wherein the distance between inner segments of the notches is a function of the length of the wires such that the inline control panel and the junction splitter are positioned within a periphery of the retaining clip when the two wires are completely wound around the plate in a winding path between the notches;
wherein the jack plug is retained within the periphery by the wires and the cable when the wires and the cable are wound around the plate.

2. The retaining clip of claim 1, further comprising two additional notches for receiving one or both of the wires and the cable to change the length of the winding path.

3. The retaining clip of claim 1, wherein the plate is configured with at least one hole large enough to allow the jack plug to pass through, wherein the cable is retained in position by the hole.

4. The retaining clip of claim 1, the at least one first cutout comprising first and second rounded notches formed in one edge of the plate.

5. The retaining clip of claim 1, the plate being substantially flat.

6. The retaining clip of claim 1, the plate further comprising an alignment notch on an edge of the plate for receiving the wires and aligning and retaining the earpieces within the first cutout.

7. The retaining clip of claim 1, the plate further comprising a second pair of notches separated by a distance different distance than the distance between the first pair of notches, wherein the distance between the inner segments of the second pair of notches is a function of the length of the wires and the cable such that when at least part each of one or both of the wires and the cable is wound around the second pair of notches, the junction splitter, inline control panel, and jack plug are positioned substantially within a periphery of the plate.

8. The retaining clip of claim 1, the plate further comprising a second pair of notches having a variable distance between inner segments, wherein at least part each of one or both of the wires and the cable are wound around the second pair of notches to position the junction splitter, inline control panel, and jack plug substantially within a periphery of the plate.

9. The retaining clip of claim 1, the plate further comprising a second cutout for receiving and securing the jack plug.

10. The retaining clip of claim 1, wherein the cutout comprises a recess shaped to receive the earpieces.

11. The retaining clip of claim 10, the shaped recess being further shaped to receive stems of the earpieces.

12. The retaining clip of claim 1, the plate further comprising an elastic loop for securing the earphone set to the clip.

13. A case for storing an earphone set proximate to a digital media device (DMD), comprising:
a top component forming a storage compartment for storing the earphone set; and
a coupling mechanism for attaching the top component to the DMD such that the storage compartment is proximate a rear side of the DMD.

14. The case of claim 13, the top component comprising a stretchable material that is substantially flat when the storage compartment is empty and that is deformable by items stored within the storage compartment.

15. The case of claim 14, the stretchable material selected from the group including Neoprene, Yamamoto Neoprene, “limestone” based neoprenes, woven fabric, pleated fabric, nylon, elastic, and rubber.

16. The case of claim 13, further comprising a bottom component, wherein the coupling mechanism attaches the top component to the bottom component and wherein the bottom component couples with the DMD.

17. The case of claim 16, wherein the bottom component is a battery compartment cover of the DMD.

18. The case of claim 16, wherein the bottom component is a protective case for covering and protecting the DMD.

19. The case of claim 18, the coupling mechanism comprising a plurality of hooks that couple with receptacles formed in the bottom component.

20. The case of claim 16, further comprising an earphone retaining clip attached to the bottom component by a hinge.

21. The case of claim 20, wherein the earphone retaining clip is detachable from the bottom component.

22. The case of claim 13, wherein the DMD is selected from the group including an iPod, an iPhone, an iPad, an iTouch, a notebook computer, a laptop computer, a personal DVD player, an MP3 player, a cell phone, and a personal digital assistant (PDA).

23. The case of claim 13, further comprising a foam former for receiving an earpiece, the foam former having a recess shaped to receive the earpiece.

24. The case of claim 16, the coupling mechanism comprising one or more of hook and loop fasteners, a hinge, and at least one magnet.

25. The case of claim 18, the top component comprising:
a substantially rectangular frame with an aperture; and
a stretchable material attached to the frame and covering the aperture;
wherein the coupling mechanism comprises a hinge.

26. The case of claim 14, further comprising an opening formed in the stretchable material for accessing the storage compartment.

27. The case of claim 16, the top component comprising a substantially rigid shell.

28. The case of claim 27, the top component comprising a plurality of finger grips.

29. The case of claim 27, the coupling mechanism comprising a plurality of retention posts formed with the top component and a plurality of retaining slots formed with the base portion.

30. The case of claim 27, the coupling mechanism comprising:
a hinge positioned at a first side of the top component and the bottom component; and
a locking mechanism positioned at a second side of the top component and the bottom component that is opposite the first side.

31. A case for storing an earphone set proximate to a digital media device (DMD), comprising:
a protective DMD case for coupling with the DMD;
a storage compartment formed from stretchable material and comprising an opening for accessing the storage compartment; and
a retention clip for holding the earphone set in the storage compartment;
wherein the storage compartment is coupled to the protective DMD case, and wherein the stretchable pocket conforms to a contour of the retention clip and the earphone set held thereby, and wherein the retention clip is removable from the storage compartment through the opening.

32. The case of claim 31, wherein the stretchable material comprises one or more of. Neoprene, Yamamoto Neoprene, “limestone” based neoprenes, woven fabric, pleated fabric, nylon, elastic, and rubber.

33. The case of claim 31, further comprising a zipper for closing the opening.

34. The case of claim 31, further comprising:
a first pocket for coupling with a first end of the DMD; and
a second pocket for coupling with a second end of the DMD.

35. The case of claim 31, wherein the storage compartment is substantially rectangular and wherein each corner of the storage compartment is coupled to a respective corner of the protective case.

36. A retractable earphone storage case for storing an earphone set proximate to a digital media device (DMD), comprising:
a DMD protective case;
a storage compartment positioned on a rear of the DMD protective case and having at least one opening; and
a retractable mechanism positioned within the storage compartment for storing the earphone set such that earpieces of the earphone set may be withdrawn from the case.
